(19) United States
(12) Patent Application Publication
(10) Pub. No.: US 2006/0235163 A1
(43) Pub. Date: Oct. 19, 2006

(54) Photorefractive composition

(76) Inventors: Michiharu Yamamoto, Carlsbad, CA (US); Nasser Peyghambarian, Tucson, AZ (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/360,161

(22) Filed: Feb. 23, 2006

Related U.S. Application Data
(60) Provisional application No. 60/670,770, filed on Apr. 13, 2005.

(51) Int. Cl. C08F 20/10

(52) U.S. Cl. 525/330.3

(57) ABSTRACT

Photorefractive compositions are described. The compositions exhibit the following performances: a) Response time is less than 100 msec.; b) Initial diffraction efficiency is higher than 30%; and c) Grating holding ratio which is defined as [η(4 min.)/η(initial)]×100 is higher than 10%, wherein the η(4 min.) is a diffraction efficiency after 4 minutes and the η(initial) is an initial diffraction efficiency.

### CROSS-REFERENCE TO RELATED APPLICATIONS

This application claims the benefit of U.S. Provisional Application No. 60/670,770, filed Apr. 13, 2005, the disclosure of which is hereby incorporated by reference in its entirety.

### BACKGROUND OF THE INVENTION

1. Field of the Invention

The invention relates to photorefractive compositions comprising chromophores and a co-polymer. More particularly, the invention relates to photorefractive compositions composing at least two different types of chromophores (Type-A/Type-B) and a matrix polymer. The compositions can be used for holographic data storage or image recording materials and device area.

2. Description of the Related Art

Photorefractivity is a phenomenon in which the refractive index of a material can be altered by changing the electric field within the material, for example, by laser beam irradiation. The change of the refractive index is achieved by a series of steps including: (1) charge generation by laser irradiation, (2) charge transport, resulting in the separation of positive and negative charges, and (3) trapping of one type of charge (charge delocalization), (4) formation of a non-uniform internal electric field (space-charge field) as a result of the charge delocalization, and (5) refractive index change induced by the non-uniform electric field.

Therefore, good photorefractive properties can be seen only for materials that combine good charge generation, good charge transport or photoconductivity, and good electro-optical activity.

Photorefractive materials have many promising applications such as high-density optical data storage, dynamic holography, optical image processing, phase conjugated mirrors, optical computing, parallel optical logic, and pattern recognition. Particularly, long lasting grating behavior can contribute significantly to high-density optical data storage or holographic display applications.

Originally, the photorefractive effect was found in a variety of inorganic electro-optical (EO) crystals such as LiNbO₃. In these materials, the mechanism of the refractive index modulation by the internal space-charge field is based on a linear electro-optical effect.

In 1990 and 1991, the first organic photorefractive crystal and polymeric photorefractive materials were discovered and reported. Such materials are disclosed, for example, in U.S. Pat. No. 5,064,264 to Ducharme et al. Organic photorefractive materials offer many advantages over the original inorganic photorefractive crystals, such as large optical nonlinearities, low dielectric constants, low cost, lightweight, structural flexibility, and ease of device fabrication. Other important characteristics that may be desirable depending on the application include sufficiently long shelf life, optical quality, and thermal stability. These kinds of active organic polymers are emerging as key materials for advanced information and telecommunication technology.

In recent years, efforts have been made to optimize the properties of organic, particularly polymeric, photorefractive materials. As mentioned above, good photorefractive properties depend upon good charge generation, good charge transport (also known as photoconductivity), and good electro-optical activity. Various studies on the selection and combination of components that contribute to each of these features have been conducted. The photoconductive capability is frequently provided by incorporating materials containing carbazole groups. Phenyl amine groups can also be used for the charge transport part of the material.

Non-linear optical ability is generally provided by including chromophore compounds, such as an azo-type dye, which can absorb photon radiation. The chromophore may also provide adequate charge generation. Alternatively, a material known as a sensitizer may be added to provide or boost the mobile charge required for photorefractivity to occur.

The photorefractive composition may be made by mixing the molecular components that provide the individual properties required into a host polymer matrix. However, most of previous prepared compositions did not show good photorefractivity performances, which are high diffraction efficiency, a fast response time and long-term stability.

Efforts have been made, therefore, to provide compositions which show high diffraction efficiency, fast response time, and long stability. Examples of polymer based good photorefractive materials are disclosed in the prior art.

U.S. Pat. No. 6,653,421B1 (photorefractive composition) and U.S. Pat. No. 6,610,809B1 (polymer, producing method thereof, and photorefractive composition) to Nitto Denko Technical disclose (meth)acrylate-based polymers and copolymer based materials which showed high diffraction efficiency, fast response time, and long-term phase stability. The materials also showed fast response time of less than 30 msec and diffraction efficiency of higher than 50%, along with no phase separation for at least two or three months.

None of the materials described above achieves an optimum combination of high diffraction efficiency with fast response time and long-term stability, along with long holding grating ability. Thus, there remains a need for photorefractive compositions that combine all of these attributes, which mean that the compositions show some grating signal behavior even after several minutes for data or image storage purposes.

### SUMMARY OF THE INVENTION

Preferred embodiments of the present invention provide a photorefractive composition which exhibits fast response time and high diffraction efficiency, along with long diffractive grating lasting time and very phase stable composition. By inventors, various chromophore studies have been done. Several excellent chromophores and their containing photorefractive compositions, which show very good photorefractive performances described in the above, have been found in this invention.

Embodiments of the invention are directed to photorefractive compositions which exhibit the following performances: a) Response time is less than 100 msec., b)

Initial diffraction efficiency is higher than 30%, and c) Grating holding ratio which is defined as [η(4 min.)/η(initial)]×100 is higher than 10%, wherein the η(4 min.) is a diffraction efficiency after 4 minutes and the η(initial) is an initial diffraction efficiency.

In preferred embodiments, the photorefractive composition comprises at least two different types of chromophores and a co-polymer, wherein one type (Type-A) of chromophore is selected from the group consisting of formulae (i) and (ii), another type (Type-B) of chromophore is selected from the group consisting of formulae (iii) and (iv), and the co-polymer comprises both a repeating unit including a moiety selected from the group consisting of the structures (x), (xi), and (xii) and a repeating unit of the structure (xvi):
(Type-A): 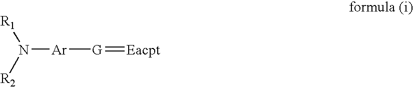
wherein Ar represents an aromatic group, with or without a hetero atom; R₁ and R₂ are each independently selected from the group consisting of a linear alkyl group with up to 10 carbons, a branched alkyl group with up to 10 carbons, and an aromatic group with up to 10 carbons; G is a group having a bridge of π-conjugated bond; and Eacpt is an electron acceptor group; 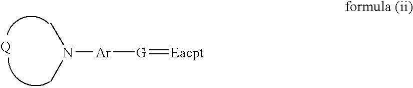
wherein Ar represents an aromatic group, with or without a hetero atom; G is a group having a bridge of π-conjugated bond; Eacpt is an electron acceptor group; and Q represents an alkylene group, with or without a hetero atom;
(Type-B): 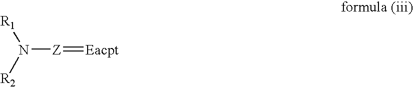
wherein R₁ and R₂ are each independently selected from the group consisting of a linear alkyl group with up to 10 carbons, a branched alkyl group with up to 10 carbons, and an aromatic group with up to 10 carbons; Z is a group having a bridge of π-conjugated bond; and Eacpt is an electron acceptor group; 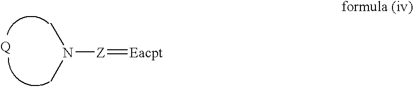
wherein Q represents an alkylene group, with or without a hetero atom; Z is a group having a bridge of π-conjugated bond; and Eacpt is an electron acceptor group;
(Polymer): 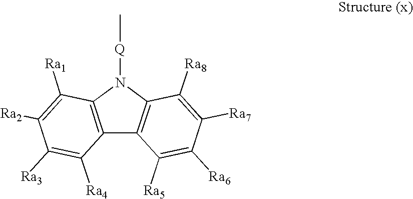
wherein Q represents an alkylene group, with or without a hetero atom; Ra₁, Ra₂, Ra₃, Ra₄, Ra₅, Ra₆, Ra₇, and Ra₈ are independently selected from the group consisting of a hydrogen atom, a linear alkyl group with up to 10 carbons, a branched alkyl group with up to 10 carbons, and an aromatic group with up to 10 carbons; 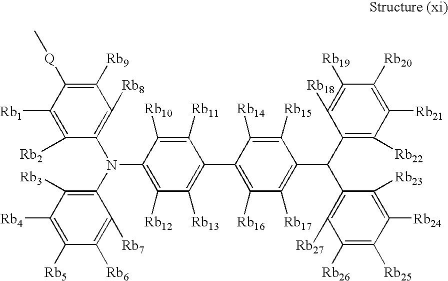
wherein Q represents an alkylene group, with or without a hetero atom; Rb₁-Rb₂₇ are each independently selected from the group consisting of a hydrogen atom, a linear alkyl group with up to 10 carbons, a branched alkyl group with up to 10 carbons, and an aromatic group with up to 10 carbons; 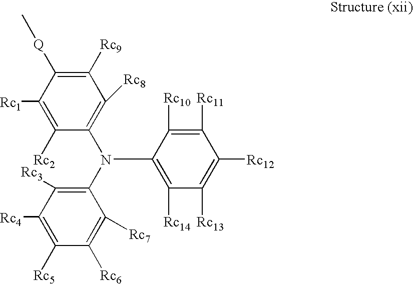
wherein Q represents an alkylene group, with or without a hetero atom; Rc₁-Rc₁₄ are each independently selected from the group consisting of a hydrogen atom, a linear alkyl group with up to 10 carbons, a branched alkyl group with up to 10 carbons, and an aromatic group with up to 10 carbons; 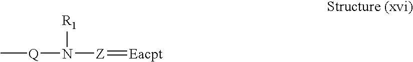
wherein Q, R₁, Z and Eacpt are the same meaning as in formula (iii) or (iv).

In preferred embodiments, the one type (Type-A) of chromophore is represented by the formula (i): 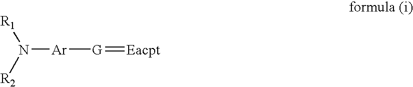
wherein Ar is an aromatic group selected from the group consisting of phenylene, naphthylene, and thiophenylene; G is represented by a structure selected from the group consisting of the structures (v) and (vi);
wherein structures (v) and (vi) are: 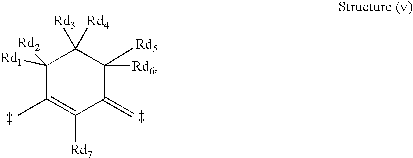
wherein, Rd₁-Rd₇ are each independently selected from the group consisting of a hydrogen atom, a linear alkyl group with up to 10 carbons, a branched alkyl group with up to 10 carbons, and an aromatic group with up to 10 carbons; 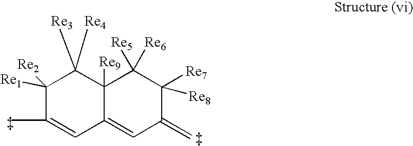
wherein Re₁-Re₉ each independently represent hydrogen or a linear or branched alkyl group with up to 10 carbons; and
wherein Eacpt in the formula (i) is an electron acceptor group represented by a structure selected from the group consisting of the following structures; 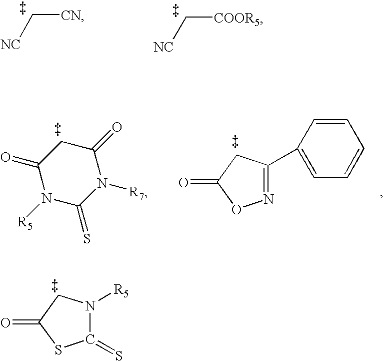
wherein R₅, R₆, R₇ and R₈ are each independently selected from the group consisting of a hydrogen atom, a linear alkyl group with up to 10 carbons, a branched alkyl group with up to 10 carbons, and an aromatic group with up to 10 carbons.

In preferred embodiments, the one type (Type-A) of chromophore is represented by the formula (ii): 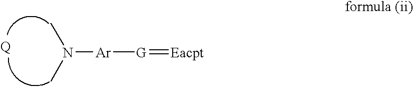
wherein Ar is an aromatic group selected from the group consisting of phenylene, naphthylene, and thiophenylene; Q represents an alkylene group, with or without a hetero atom; G is represented by a structure selected from the group consisting of the structures (v) and (vi); wherein structures (v) and (vi) are: 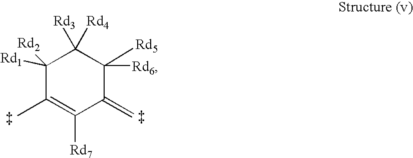
wherein, Rd₁-Rd₇ are each independently selected from the group consisting of a hydrogen atom, a linear alkyl group with up to 10 carbons, a branched alkyl group with up to 10 carbons, and an aromatic group with up to 10 carbons; 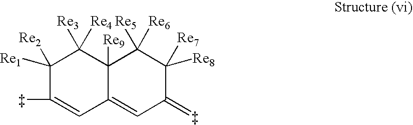
wherein Re₁-Re₉ each independently represent hydrogen or a linear or branched alkyl group with up to 10 carbons; and
wherein Eacpt in the formula (ii) is an electron acceptor group represented by a structure selected from the group consisting of the following structures; 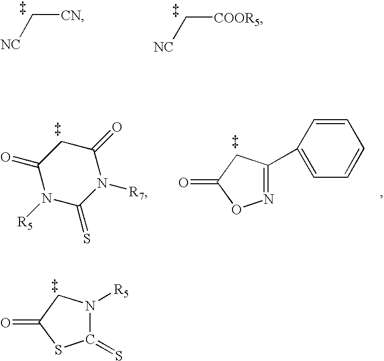
wherein R₅, R₆, R₇ and R₈ are each independently selected from the group consisting of a hydrogen atom, a linear alkyl group with up to 10 carbons, a branched alkyl group with up to 10 carbons, and an aromatic group with up to 10 carbons.

In preferred embodiments, the another type (Type-B) of chromophore is represented by the formula (iii): 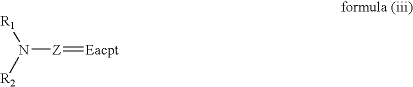
wherein R₁ and R₂ are each independently selected from the group consisting of a linear alkyl group with up to 10 carbons, a branched alkyl group with up to 10 carbons, and an aromatic group with up to 10 carbons; Z is a group selected from the group consisting of the structures (vii) and (viii);
wherein structures (vii) and (viii) are: 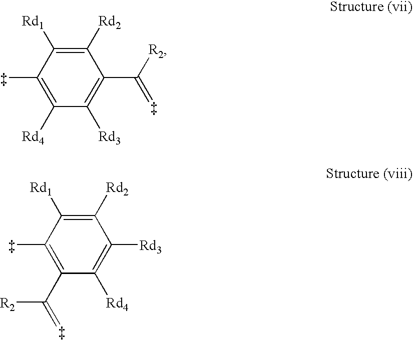
wherein, in both structures (vii) and (viii), Rd₁-Rd₄ are each independently selected from the group consisting of a hydrogen atom, a linear alkyl group with up to 10 carbons, a branched alkyl group with up to 10 carbons, and an aromatic group with up to 10 carbons; R₂ is selected from the group consisting of a hydrogen atom, a linear alkyl group with up to 10 carbons, a branched alkyl group with up to 10 carbons, and an aromatic group with up to 10 carbons; and
wherein Eacpt in formula (iii) is an electron acceptor group represented by a structure selected from the group consisting of the following structures; 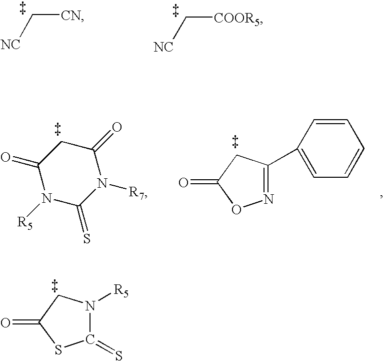
wherein R₅, R₆, R₇ and R₈ are each independently selected from the group consisting of a hydrogen atom, a linear alkyl group with up to 10 carbons, a branched alkyl group with up to 10 carbons, and an aromatic group with up to 10 carbons.

In preferred embodiments, the another type (Type-B) of chromophore is represented by the formula (iv): 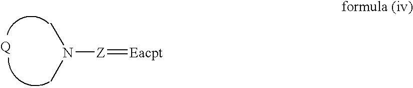
wherein Q represents an alkylene group, with or without a hetero atom; Z is a group selected from the group consisting of the structures (vii) and (viii);
wherein structures (vii) and (viii) are: 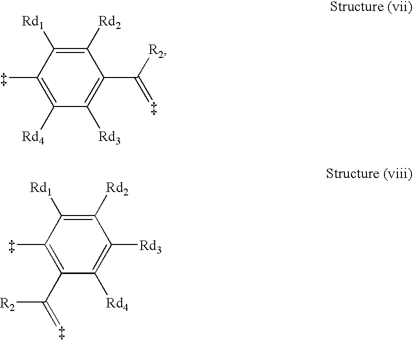
wherein, in both structures (vii) and (viii), Rd₁-Rd₄ are each independently selected from the group consisting of a hydrogen atom, a linear alkyl group with up to 10 carbons, a branched alkyl group with up to 10 carbons, and an aromatic group with up to 10 carbons; R₂ is selected from the group consisting of a hydrogen atom, a linear alkyl group with up to 10 carbons, a branched alkyl group with up to 10 carbons, and an aromatic group with up to 10 carbons; and
wherein Eacpt in formula (iv) is an electron acceptor group represented by a structure selected from the group consisting of the following structures; 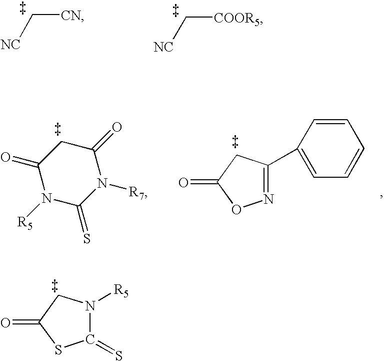
wherein R₅, R₆, R₇ and R₈ are each independently selected from the group consisting of a hydrogen atom, a linear alkyl group with up to 10 carbons, a branched alkyl group with up to 10 carbons, and an aromatic group with up to 10 carbons.

In preferred embodiments, the co-polymer comprises both a repeating unit selected from the group consisting of the structures (xiii), (xiv), and (xv) and a repeating unit of the structure (xvii): 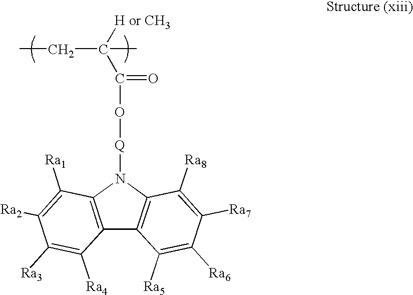
wherein Q represents an alkylene group, with or without a hetero atom; Ra₁, Ra₂, Ra₃, Ra₄, Ra₅, Ra₆, Ra₇, and Ra₈ are independently selected from the group consisting of a hydrogen atom, a linear alkyl group with up to 10 carbons, a branched alkyl group with up to 10 carbons, and an aromatic group with up to 10 carbons; 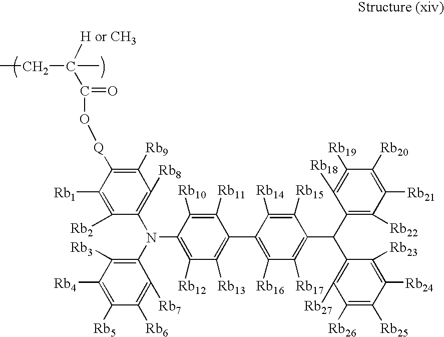
wherein Q represents an alkylene group, with or without a hetero atom; Rb₁-Rb₂₇ are each independently selected from the group consisting of a hydrogen atom, a linear alkyl group with up to 10 carbons, a branched alkyl group with up to 10 carbons, and an aromatic group with up to 10 carbons; 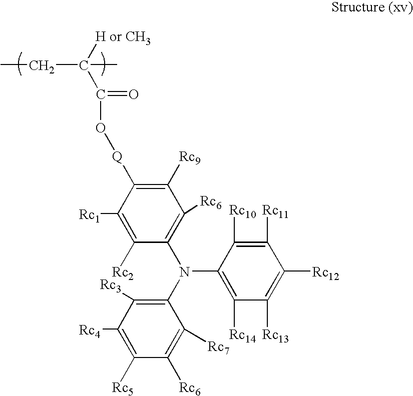
wherein Q represents an alkylene group, with or without a hetero atom; Rc₁-Rc₁₄ are each independently selected from the group consisting of a hydrogen atom, a linear alkyl group with up to 10 carbons, a branched alkyl group with up to 10 carbons, and an aromatic group with up to 10 carbons. 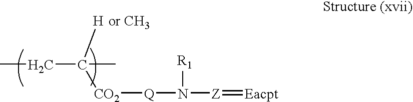
wherein Q, R₁, Z and Eacpt are the same meaning as in formula (iii) or (iv).

In preferred embodiments, the photorefractive composition comprises a plasticizer and a sensitizer.

In this case, the plasticizer is preferably N-alkyl carbazole or triphenylamine derivatives.

The photorefractive composition preferably comprises at least two different types of chromophores and a co-polymer. One type (Type-A) may be selected from fused ring bridge of π-conjugated bond. Another type (Type-B) may be selected from aniline groups. The co-polymer comprises at least one of a repeat unit including a moiety having charge transport ability. Furthermore, the photorefractive composition contains a sensitizer and a plasticizer, as desired.

The composition differs from photorefractive compositions previously known in the art in several points.

In a first point, the composition provides fast response time and high diffraction efficiency, along with good long-term phase stability such as (a) response time is less than 100 msec., (b) initial diffraction efficiency is higher than 50%, and (c) grating holding ratio which is defined as [η(4 mm.)/η(initial)]×100 is higher than 20%, wherein the η(4 min.) is a diffraction efficiency after 4 minutes and the η(initial) is an initial diffraction efficiency.

In a second point, preferred embodiments of the composition comprise a copolymer and novel chromophore systems and showed very good long-duration grating persistence behavior.

In preferred embodiments, the composition comprises mixture of both two different types of chromophores, that is Type-A and Type-B. Inventors found out that the two different types of new chromophores contribute to different functions of photorefractive behaviors, such as to longer grating lasting phenomenon (Type-A) and to give quick diffraction start-up (Type-B), without sacrificing other important photorefractive performances.

In a third point, preferred embodiments of the composition comprise newly developed plasticizers, which have both good charge transport ability moiety, such as triphenylamine derivatives, and hydrophilic moiety in the molecule. This kind of plasticizer can enhance phase stability of the composition effectively. Even if the chromophore or plasticizer functional material is mixed in the form of dopant, the composition still provides the long-term stability.

The photorefractive compositions according to the present invention have great utility in a variety of optical applications, including holographic storage, optical correlation, phase conjugation, non-destructive evaluation and imaging.

### DETAILED DESCRIPTION OF THE PREFERRED EMBODIMENT

The invention relates to photorefractive compositions. Preferred embodiments of the invention relates to photorefractive compositions comprising at least two different types of chromophores and a co-polymer. One type (Type-A) is selected from fused ring bridge of π-conjugated bond. Another type (Type-B) is selected from aniline groups. The co-polymer comprises at least one repeat unit including a moiety having charge transport ability. Furthermore, the photorefractive composition contains a sensitizer and a plasticizer, as desired. Optionally, the composition may also include other components as desired, such as sensitizer and plasticizer components.

The chromophores that provide the non-linear optical functionality used in the present invention are preferably at least two different types of chromophores and a polymer. One type (Type-A) is selected from the group consisting of formulae (i) and (ii). Another type (Type-B) is selected from the group consisting of formulae (iii) and (iv).
(Type-A)

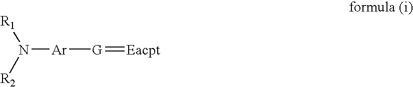

In the formula (i), Ar represents an aromatic group, with or without a hetero atom; R₁ and R₂ are each independently selected from the group consisting of a linear alkyl group with up to 10 carbons, a branched alkyl group with up to 10 carbons, and an aromatic group with up to 10 carbons. R₁ and R₂ can be either same or different. G is a group having a bridge of π-conjugated bond and Eacpt is an electron acceptor group.

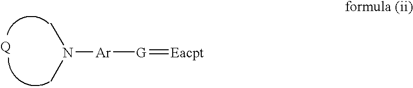

In the formula (ii), Ar represents an aromatic group, with or without a hetero atom; G is a group having a bridge of π-conjugated bond; and Eacpt is an electron acceptor group; Q represents an alkylene group, with or without a hetero atom.
(Type-B)

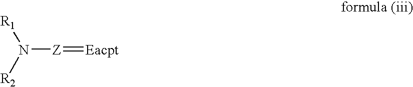

In the formula (iii), R₁ and R₂ are each independently selected from the group consisting of a linear alkyl group with up to 10 carbons, a branched alkyl group with up to 10 carbons, and an aromatic group with up to 10 carbons. R₁ and R₂ can be either same or different. Z is a group having a bridge of π-conjugated bond and Eacpt is an electron acceptor group wherein the composition exhibits photorefractive ability.

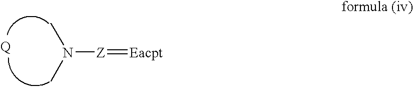

In the formula (iv), Q represents an alkylene group, with or without a hetero atom; Z is a group having a bridge of π-conjugated bond; and Eacpt is an electron acceptor group wherein the composition exhibits photorefractive ability.

In the above definition, the term “a bridge of π-conjugated bond” refers to a molecular fragment that connects two or more chemical groups by π-conjugated bond. A π-conjugated bond contains covalent bonds between atoms that have σ bonds and π bonds formed between two atoms by overlap of their atomic orbits (s+p hybrid atomic orbits for σ bonds; p atomic orbits for π bonds).

The term “electron acceptor” refers to a group of atoms with a high electron affinity that can be bonded to a π-conjugated bridge. Exemplary acceptors, in order of increasing strength, are:
C(O)NR²<C(O)NHR<C(O)NH₂<C(O)OR<C(O)OH<C(O)R<C(O)H<CN<S(O)₂R<NO₂

As typical exemplary electron acceptor groups in the above formula (i), (ii), (iii) or (iv), Eacpt is preferably an electron acceptor group represented by a structure selected from the group consisting of the following structures;

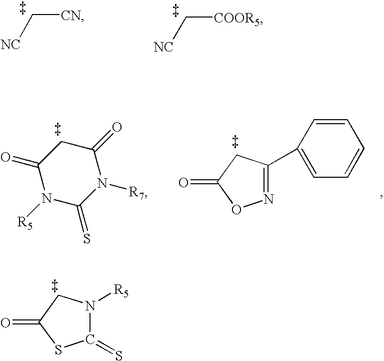

In the above structures, R₅, R₆, R₇ and R₈ are each independently selected from the group consisting of a hydrogen atom, a linear alkyl group with up to 10 carbons, a branched alkyl group with up to 10 carbons, and an aromatic group with up to 10 carbons.

Furthermore, as other exemplary electron acceptor groups, functional groups which are described in prior art of U.S. Pat. No. 6,267,913 and shown in the following structures can be used. The symbol “‡” in a chemical structure herein specifies an atom of attachment to another chemical group and indicates that the structure is missing a hydrogen that would normally be implied by the structure in the absence of the “‡”.

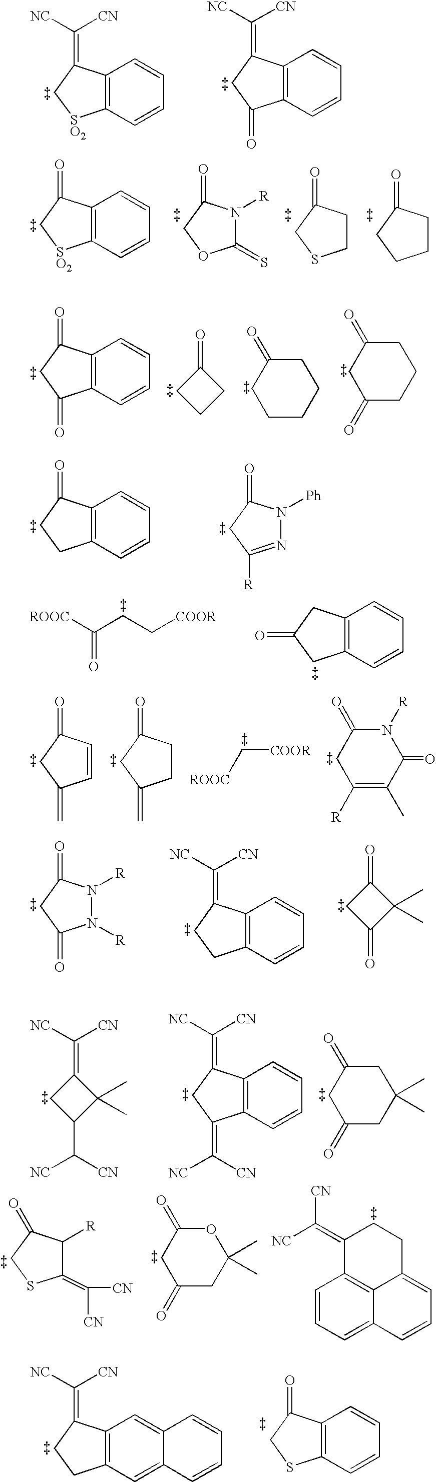

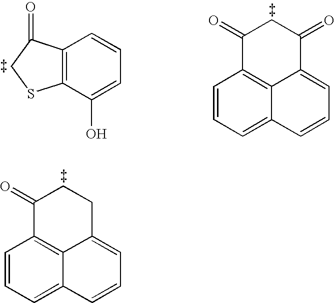

In the above structures, R is selected from the group consisting of a hydrogen atom, a linear alkyl group with up to 10 carbons, a branched alkyl group with up to 10 carbons, and an aromatic group with up to 10 carbons.

In the above formula (i) or (ii), Ar is preferably an aromatic group selected from the group consisting of phenylene, naphthylene, and thiophenylene.

Also, in the above formula (i) or (ii), G is preferably represented by a structure selected from the group consisting of the structures (v) and (vi).

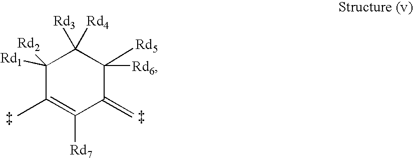

In the structure (v), Rd₁-Rd₇ are each independently selected from the group consisting of a hydrogen atom, a linear alkyl group with up to 10 carbons, a branched alkyl group with up to 10 carbons, and an aromatic group with up to 10 carbons.

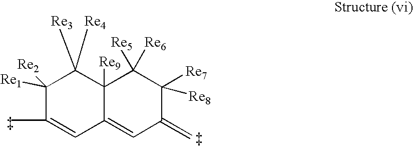

In the structure (vi), Re₁-Re₉ each independently represent hydrogen or a linear or branched alkyl group with up to 10 carbons.

In the above formula (i) or (iii), R₁ and R₂ are preferably selected from the group consisting of methyl, ethyl, propyl, isopropyl, butyl, isobutyl, pentyl, hexyl, and octyl.

In the above formula (ii) or (iv), Q is preferably selected from the group consisting of ethylene, propylene, butylene, pentylene, hexylene, and heptylene.

Most preferably the structure that provides the non linear optical functionality in the above formulae (i) and (ii) is chosen from the derivatives of the following structures:

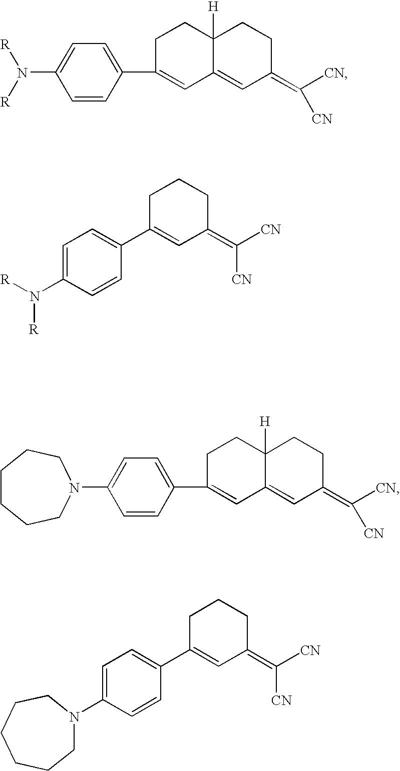

In the above structures, R is a group selected from the group consisting of a hydrogen atom, a linear alkyl group with up to 10 carbons, a branched alkyl group with up to 10 carbons, and an aromatic group with up to 10 carbons.

In the above formula (iii) or (iv), Z is preferably a group selected from the group consisting of the structures (vii) and (viii).

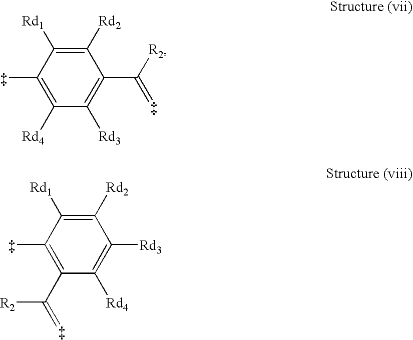

In both structures (vii) and (viii), Rd₁-Rd₄ are each independently selected from the group consisting of a hydrogen atom, a linear alkyl group with up to 10 carbons, a branched alkyl group with up to 10 carbons, and an aromatic group with up to 10 carbons; R₂ is selected from the group consisting of a hydrogen atom, a linear alkyl group with up to 10 carbons, a branched alkyl group with up to 10 carbons, and an aromatic group with up to 10 carbons.

Preferably the structure that provides the non linear optical functionality in the above formulae (iii) and (iv) is chosen from the derivatives of the following structures:

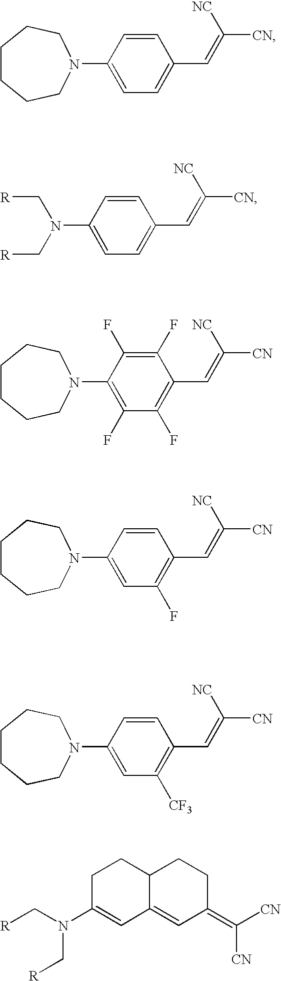

In the above structures, R is a group selected from the group consisting of a hydrogen atom, a linear alkyl group with up to 10 carbons, a branched alkyl group with up to 10 carbons, and an aromatic group with up to 10 carbons.

Furthermore, as other mixable chromophore, a component that possesses non-linear optical properties through the polymer matrix, as is described in U.S. Pat. No. 5,064,264 to IBM, which is incorporated herein by reference, can be used. Suitable materials are known in the art and are well described in the literature, such as in D. S. Chemla & J. Zyss, “Nonlinear Optical Properties of Organic Molecules and Crystals” (Academic Press, 1987). Also, as described in U.S. Pat. No. 6,090,332 to Seth R. Marder et. al., fused ring bridge, ring locked chromophores that form thermally stable photorefractive compositions can be used. For typical, non-limiting examples of chromophore additives, the following chemical structure compounds can be used:

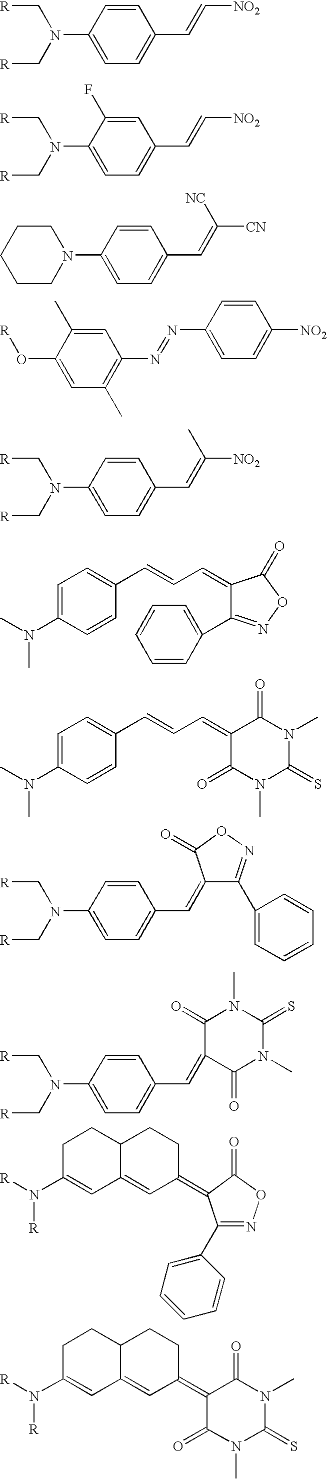

The chosen compound(s) is sometimes mixed in the matrix copolymer in a concentration of about up to 80 wt %, more preferably 40 wt %.

Based on inventors' intensive studies and discoveries, Type-A chromophores can mainly contribute to make the compositions hold grating longer and persistence. On the other hand, Type-B chromophores may give fast and quick photorefractive diffractive grating behaviors.

In this invention, another component for the photorefractive composition is a co-polymer which comprises both a repeating unit including a moiety selected from the group consisting of the structures (x), (xi), and (xii) and a repeating unit of the structure (xvi). 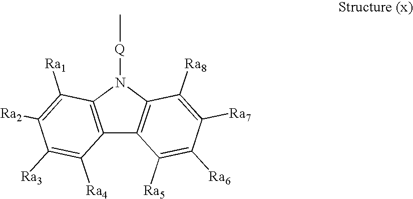
wherein Q represents an alkylene group, with or without a hetero atom, such as oxygen or sulfur, and preferably Q is an alkylene group represented by (CH₂)ₚ; where p is between about 2 and 6; and wherein Ra₁, Ra₂, Ra₃, Ra₄, Ra₅, Ra₆, Ra₇, and Ra₈ are independently selected from the group consisting of a hydrogen atom, a linear alkyl group with up to 10 carbons, a branched alkyl group with up to 10 carbons, and an aromatic group with up to 10 carbons; 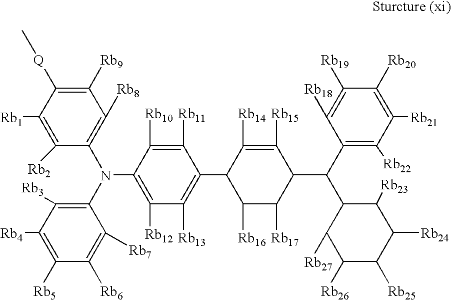
wherein Q represents an alkylene group, with or without a hetero atom, such as oxygen or sulfur, and preferably Q is an alkylene group represented by (CH₂)ₚ; where p is between about 2 and 6; and wherein Rb₁-Rb₂₇ are independently selected from the group consisting of a hydrogen atom, a linear alkyl group with up to 10 carbons, a branched alkyl group with up to 10 carbons, and an aromatic group with up to 10 carbons; 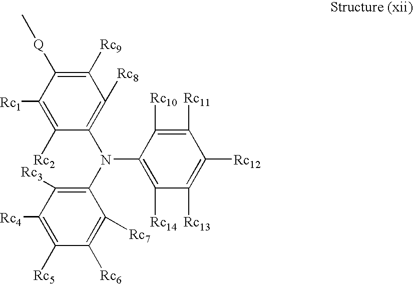
wherein Q represents an alkylene group, with or without a hetero atom, such as oxygen or sulfur, and preferably Q is an alkylene group represented by (CH₂)ₚ; where p is between about 2 and 6, and wherein Rc₁-Rc₁₄ are independently selected from the group consisting of a hydrogen atom, a linear alkyl group with up to 10 carbons, a branched alkyl group with up to 10 carbons, and an aromatic group with up to 10 carbons; and 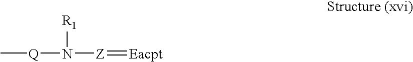
wherein Q, R₁, Z and Eacpt are the same meaning as in formula (iii) or (iv).

In principle, essentially any polymer backbone, including, but not limited to, polyurethane, epoxy polymers, polystyrene, polyether, polyester, polyamide, polyimide, polysiloxane, and polyacrylate could be used, with the appropriate side chains attached, to make the polymer matrices of the invention.

Preferred types of backbone units are those based on acrylates or styrene. Particularly preferred are acrylate-based monomers, and more preferred are methacrylate monomers. The first polymeric materials to include photoconductive functionality in the polymer itself were the polyvinyl carbazole materials developed at the University of Arizona. However, these polyvinyl carbazole polymers tend to become viscous and sticky when subjected to the heat-processing methods typically used to form the polymer into films or other shapes for use in photorefractive devices.

In contrast, inventors' preferred materials, and particularly the (meth)acrylate-based, and more specifically acrylate-based, polymers, have much better thermal and mechanical properties. That is, they provide better workability during processing by injection-molding or extrusion, for example. This is particularly true when the polymers are prepared by radical polymerization.

Preferably, the polymer comprises both a repeating unit selected from the group consisting of the structures (xiii), (xiv), and (xv) and a repeating unit of the structure (xvii); 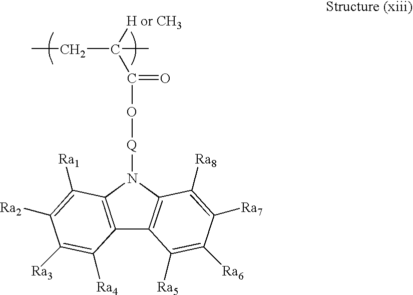
wherein Q represents an alkylene group, with or without a hetero atom; Ra₁, Ra₂, Ra₃, Ra₄, Ra₅, Ra₆, Ra₇, and Ra₈ are independently selected from the group consisting of a hydrogen atom, a linear alkyl group with up to 10 carbons, a branched alkyl group with up to 10 carbons, and an aromatic group with up to 10 carbons; 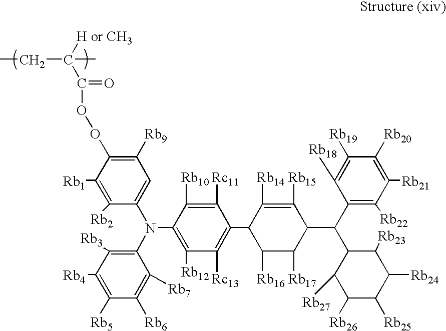
wherein Q represents an alkylene group, with or without a hetero atom; Rb₁-Rb₂₇ are each independently selected from the group consisting of a hydrogen atom, a linear alkyl group with up to 10 carbons, a branched alkyl group with up to 10 carbons, and an aromatic group with up to 10 carbons; and 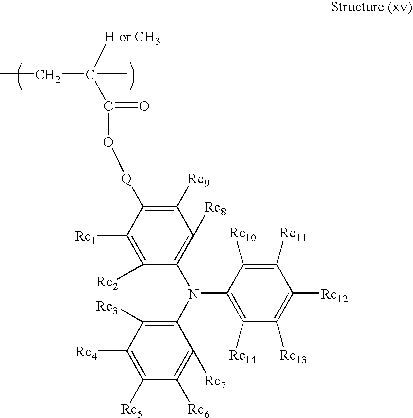
wherein Q represents an alkylene group, with or without a hetero atom; Rc₁-Rc₁₄ are each independently selected from the group consisting of a hydrogen atom, a linear alkyl group with up to 10 carbons, a branched alkyl group with up to 10 carbons, and an aromatic group with up to 10 carbons; 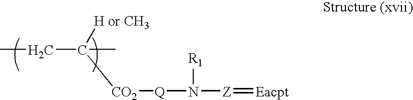
wherein Q, R₁, Z and Eacpt are the same meaning as in formula (iii) or (iv).

Particular examples of monomers including a phenyl amine derivative group as the charge transport component are carbazolylpropyl(meth)acrylate monomer; 4-(N,N-diphenylamino)-phenylpropyl(meth)acrylate; N-[(meth)acroyloxypropylphenyl]-N,N′,N′-triphenyl-(1,1′-biphenyl)-4,4′-diamine; N-[(meth)acroyloxypropylphenyl]-N′-phenyl-N,N′-di(4-methylphenyl)-(1,1′-biphenyl)-4,4′-diamine; and N-[(meth)acroyloxypropylphenyl]-N′-phenyl-N,N′-di(4-buthoxyphenyl)-(1,1′-biphenyl)-4,4′-diamine. Such monomers can be used singly or in mixtures of two or more monomers.

Diverse polymerization techniques are known in the art. One such conventional technique is radical polymerization, which is typically carried out by using an azo-type initiator, such as AIBN (azoisobutyl nitrile). In this radical polymerization method, the polymerization catalysis is generally used in an amount of from 0.01 to 5 mol %, preferably from 0.1 to 1 mol %, per mole of the sum of the polymerizable monomers.

In the present invention, conventional radical polymerization may be carried out under inactive gas and in the presence of a solvent, such as ethyl acetate, tetrahydrofuran, butyl acetate, toluene or xylene.

Usually, the generally used inactive gas is, preferably, nitrogen, argon, or helium. Polymerization pressure is from 1 to 50 atom, preferably from 1 to 5 atom.

The solvent is generally used in an amount of from 100 to 10,000 wt %, preferably from 1,000 to 5,000 wt %, per weight of the sum of the polymerizable monomers.

The conventional radical polymerization is preferably carried out at a temperature of from about 50° C. to 100° C., and is allowed to continue for about 1 to 100 hours, depending on the desired final molecular weight and polymerization temperature, and taking into account the polymerization rate.

As another radical polymerization method, living radical polymerization method may be used.

Details of the living radical polymerization method are described in the literature. They may be found, for example, in the following papers:
T. Patten et al., “Radical polymerization yielding polymers with Mw/Mn˜1.05 by homogeneous atom transfer radical polymerization”, Polymer Preprints, 1996, 37, 575.
K. Matyjasewski et al., “Controlled/living radical polymerization. Halogen atom transfer radical polymerization promoted by a Cu(I)/Cu(II) redox process”, Macromolecules, 1995, 28, 7901.
M. Sawamoto et al., “Ruthenium-mediated living radical polymerization of methyl methacrylate”, Macromolecules, 1996, 29, 1070.

This living radical polymerization methodology is also described at length in U.S. Pat. No. 5,763,548 to Carnegie-Mellon University, which is incorporated herein by reference in its entirety.

Briefly, inventors' living radical polymerization technique preferably involves the use of a polymerization initiator, a catalyst and an activating agent.

The initiator may be typically a halogen-containing organic compound. After polymerization, this initiator or components of the initiator are attached to the polymer at both polymer terminals. The polymerization initiator preferably used is an ester-based or styrene-based derivative containing a halogen in the α-position. Particularly preferred are 2-bromo(or chloro)methylpropionic acid, or bromo(or chloro)-1-phenyl derivatives. Specific examples of these derivatives include ethyl 2-bromo(or chloro)-2-methylpropionate, ethyl 2-bromo(or chloro)propionate, 2-hydroxyethyl 2-bromo(or chloro)-2-methylpropionate, 2-hydroxyethyl 2-bromo(or chloro)propionate, and 1-phenyl ethyl bromide(chloride).

In inventors' process, the polymerization initiator is generally used in an amount of from 0.01 to 20 mol %, preferably from 0.1 to 10 mol %, and more preferably from 0.2 to 5 mol %, per mole of the sum of the polymerizable monomers.

Various types of catalysts are known, including perfluoroalkyl iodide type, TEMPO (phenylethoxy-tetramethylpiperidine) type, and transition metal type. Inventors have discovered that high-quality polymers can be made by using transition-metal catalysts, which are safer, simpler, and more amenable to industrial-scale operation than TEMPO-type catalysts. Therefore, in the process of the invention a transition-metal catalyst is preferred.

Non-limiting examples of transition metals that may be used include Cu, Ru, Fe, Rh, V, and Ni. Particularly preferred is Cu. Typically, but not necessarily, the transition metal is used in the form of the metal halide (chloride, bromide, etc.).

The transition metal in the form of a halide or the like is generally used in the amount of from 0.01 to 3 moles, and preferably from 0.1 to 1 mole, per mole of polymerization initiator.

The activating agent is an organic ligand of the type known in the art that can be reversibly coordinated with the transition metal as a center to form a complex. The ligand preferably used is a bipyridine derivative, mercaptans derivative, trifluorate derivative, or the like. When complexed with the activating ligand, the transition metal catalyst is rendered soluble in the polymerization solvent. In other words, the activating agent serves as a co-catalyst to activate the catalyst, and start the polymerization.

The ligand is used in an amount of normally from 1 to 5 moles, and preferably from 2 to 3 moles, per mole of transition metal halide.

The use of the polymerization initiator and the activating agent in the above recommended proportions makes it possible to provide good results in terms of the reactivity of the living radical polymerization and the molecular weight and weight distribution of the resulting polymer.

Living radical polymerization can be carried out without a solvent or in the presence of a solvent, such as butyl acetate, toluene or xylene.

To initiate the polymerization process, the monomer(s), polymerization initiator, catalyst, activating agent and solvent may be introduced into the reaction vessel. As the process starts, the catalyst and polymerization initiator form a radical, which attacks the monomer and starts the polymerization growth.

The living radical polymerization is preferably carried out at a temperature of from about 70° C. to 130° C., and is allowed to continue for about 1 to 100 hours, depending on the desired final molecular weight and polymerization temperature, and taking into account the polymerization rate and deactivation of catalyst.

Furthermore, by carrying out the radical polymerization technique based on the teachings and preferences given above, it is possible to prepare random or block copolymers carrying both charge transport and non-linear optical groups. Further, by following the techniques described herein, it is possible to prepare such materials with exceptionally good properties, such as photoconductivity, response time and diffraction efficiency.

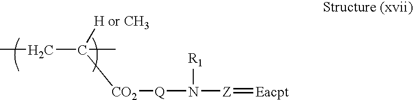

In structure (xvii), Q, R₁, Z and Eacpt are the same meaning as in formula (iii) or (iv).

Particular examples of monomers including a chromophore group as the non-linear optical component are N-ethyl, N-4-dicyanomethylidenyl acrylate and N-ethyl, N-4-dicyanomethylidenyl-3,4,5,6,10-pentahydronaphtylpentyl acrylate.

The copolymer matrix is preferably synthesized from a monomer incorporating both a repeating unit selected from the group consisting of the structures (xiii), (xiv), and (xv) and a repeating unit of the structure (xvii).

To prepare the non-linear optical containing copolymer, monomers that have side-chain groups possessing non-linear-optical ability may be used. Non-limiting examples of monomers that may be used are those containing the following chemical structures: 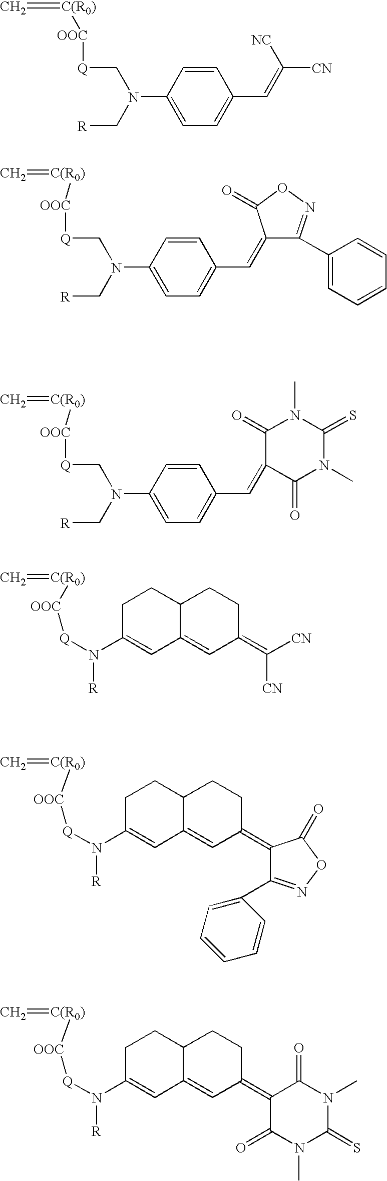
wherein Q represents an alkylene group with or without a hetero atom, such as oxygen or sulfur, and preferably Q is an alkylene group represented by (CH₂)ₚ; where p is between about 2 and 6; R₀ is a hydrogen atom or methyl group, and R is a linear or branched alkyl group with up to 10 carbons; and preferably R is a alkyl group which is selected from methyl, ethyl, or propyl.

Inventors have discovered a new technique for preparing the invention copolymers. Inventors' technique preferably involves the use of a precursor monomer containing a precursor functional group for non-linear optical ability. Typically, this precursor is represented by the following general formula 0: 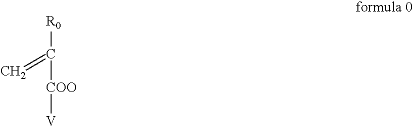
wherein R₀ is a hydrogen atom or methyl group, and V is selected from the group consisting of the following structures 1 and 2:

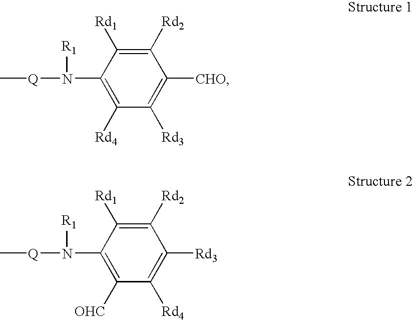

wherein, in both structures 1 and 2, Q represents an alkylene group, with or without a hetero atom, such as oxygen or sulfur, and preferably Q is an alkylene group represented by (CH₂)ₚ; where p is between about 2 and 6; and wherein Rd₁-Rd₄ are independently selected from the group consisting of a hydrogen atom, a linear alkyl group with up to 10 carbons, a branched alkyl group with up to 10 carbons, and an aromatic group with up to 10 carbons, and preferably Rd₁-Rd₄ are hydrogen; and wherein R₁ represents a linear or branched alkyl group with up to 10 carbons, and preferably R₁ is an alkyl group selected from methyl, ethyl, propyl, butyl, pentyl or hexyls.

The procedure for performing the radical polymerization in this case involves the use of the same polymerization methods and operating conditions with same preferences, as have already been described above.

After the precursor copolymer has been formed, it can be converted into the corresponding copolymer having non-linear optical groups and capabilities by a condensation reaction. Typically, the condensation reagent may be selected from the group consisting of 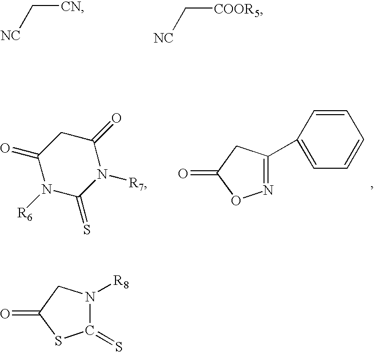
wherein R₅, R₆, R₇ and R₈ are each independently selected from the group consisting of a hydrogen atom, a linear alkyl group with up to 10 carbons, a branched alkyl group with up to 10 carbons, and an aromatic group with up to 10 carbons.

The condensation reaction may be done at room temperature for 1-100 hrs, in the presence of a pyridine derivative catalyst. A solvent, such as butyl acetate, chloroform, dichloromethylene, toluene or xylene may be used. Optionally, the reaction may be carried out without the catalyst at a solvent reflux temperature of 30° C. or above for about 1 to 100 hours.

Inventors have discovered that use of a monomer containing a precursor group for non-linear-optical ability, and conversion of that group after polymerization tends to result in a polymer product of lower polydispersity than the case if a monomer containing the non-linear-optical group is used. This is, therefore, inventors' preferred technique.

Also, there are no restrictions on the ratio of monomer units for copolymers which comprise a repeating unit including the first moiety having charge transport ability, a repeating unit including the second moiety having non-linear-optical ability, and a repeating unit including the third moiety having plasticizing ability. However, as a typical representative example, per 100 weight parts of [a (meth)acrylic monomer having charge transport ability], [a (meth)acrylate monomer having non-linear optical ability] is a range between 1 and 200 weight parts, preferably a range between 10 and 100 weight parts. If this ratio is less than about 1 weight part, the charge transport ability of copolymer itself is weak, and the response time tends to be too slow to give good photorefractivity. However, even in this case, by addition of low molecular weight components having non-linear-optical ability can enhance photorefractivity. On the other hand, if this ratio is more than about 200 weight parts, the non-linear-optical ability of copolymer itself is weak, and the diffraction efficiency tends to be too low to give good photorefractivity. However, even in this case, by addition of low molecular weight components having charge transport ability can enhance photorefractivity.

The inventors have recognized that physical properties of the formed copolymer that are of importance are the molecular weight and the glass transition temperature, Tg. Also, it is valuable and desirable, although not essential, that the composition should be capable of being formed into films, coatings and shaped bodies of various kinds by standard polymer processing techniques, such as solvent coating, injection molding and extrusion.

In the present invention, the polymer generally has a weight average molecular weight, Mw, of from about 3,000 to 500,000, preferably from about 5,000 to 100,000. The term “weight average molecular weight” as used herein means the value determined by the GPC (gel permeation chromatography) method in polystyrene standards, as is well known in the art.

The copolymer may be mixed with a component that possesses plasticizer properties into the polymer matrix. As preferred plasticizer compounds, any commercial plasticizer compound can be used, such as phthalate derivatives or low molecular weight hole transfer compounds, for example N-alkyl carbazole, triphenylamine derivatives, acetyl carbazole, and triphenylamine derivatives.

As detail examples, ethyl carbazole, 4-(N,N-diphenylamino)-phenylpropyl acetate; 4-(N,N-diphenylamino)-phenylmethyloxy acetate; N-(acetoxypropylphenyl)-N,N′,N′-triphenyl-(1,1′-biphenyl)-4,4′-diamine; N-(acetoxypropylphenyl)-N′-phenyl-N,N′-di(4-methylphenyl)-(1,1′-biphenyl)-4,4′-diamine; and N-(acetoxypropylphenyl)-N′-phenyl-N,N′-di(4-buthoxyphenyl)-(1,1′-biphenyl)-4,4′-diamine. Such compounds can be used singly or in mixtures of two or more monomers. Also, un-polymerized monomers can be low molecular weight hole transfer compounds, for example 4-(N,N-diphenylamino)-phenylpropyl(meth)acrylate; N-[(meth)acroyloxypropylphenyl]-N,N′,N′-triphenyl-(1,1′-biphenyl)-4,4′-diamine; N-[(meth)acroyloxypropylphenyl]-N′-phenyl-N,N′-di(4-methylphenyl)-(1,1′-biphenyl)-4,4′-diamine; and N-[(meth)acroyloxypropylphenyl]-N′-phenyl-N,N′-di(4-buthoxyphenyl)-(1,1′-biphenyl)-4,4′-diamine. Such monomers can be used singly or in mixtures of two or more monomers.

Preferably, as another type of plasticizer, N-alkyl carbazole or triphenylamine derivatives, which contains electron acceptor group, as depicted in the following structure 4, 5, and 6, can be used. 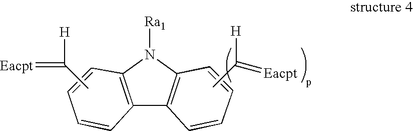
wherein Ra₁ is independently selected from the group consisting of a hydrogen atom, a linear alkyl group with up to 10 carbons, a branched alkyl group with up to 10 carbons, and an aromatic group with up to 10 carbons; p is 0 or 1; 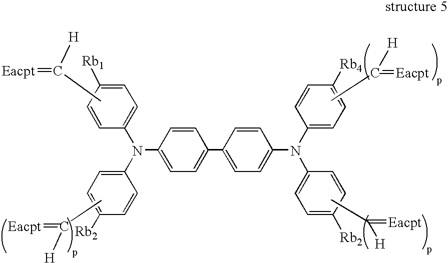
wherein Rb₁-Rb₄ are each independently selected from the group consisting of a hydrogen atom, a linear alkyl group with up to 10 carbons, a branched alkyl group with up to 10 carbons, and an aromatic group with up to 10 carbons; p is 0 or 1; 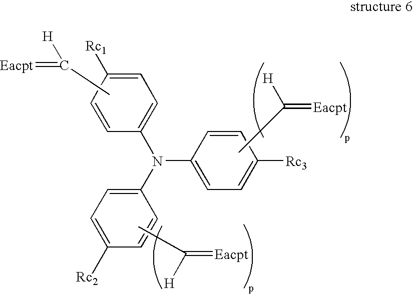
wherein Rc₁-Rc₃ are each independently selected from the group consisting of a hydrogen atom, a linear alkyl group with up to 10 carbons, a branched alkyl group with up to 10 carbons, and an aromatic group with up to 10 carbons; P is 0 or 1;
wherein Eacpt is an electron acceptor group and represented by a structure selected from the group consisting of the structures; 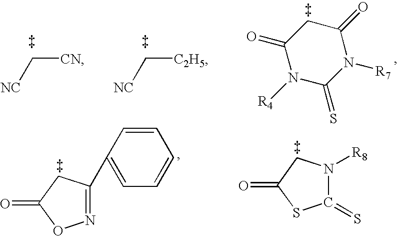
wherein R₅, R₆, R₇ and R₈ are each independently selected from the group consisting of a hydrogen atom, a linear alkyl group with up to 10 carbons, a branched alkyl group with up to 10 carbons, and an aromatic group with up to 10 carbons.

The plasticizer, which is N-alkyl carbazole or triphenylamine derivatives containing electron acceptor group and depicted in the structure 4, 5, or 6, can help the photorefractive composition more stable, since the plasticizer contains both N-alkyl carbazole or triphenylamine moiety and non-liner optics moiety at same time in one compound.

As detail examples of the above described plasticizers, the following compound may be used. Such monomers can be used singly or in mixtures of two or more monomers.

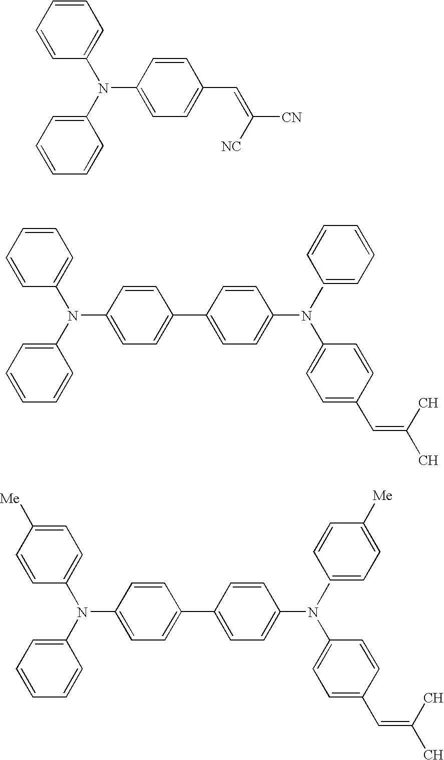

As discussed above, preferred embodiments of the invention provide polymers of comparatively low Tg when compared with similar polymers prepared in accordance with prior art methods. Inventors have recognized that this provides a benefit in terms of lower dependence on plasticizers. By selecting copolymers of intrinsically moderate Tg and by using methods that tend to depress the average Tg, it is possible to limit the amount of plasticizer required for the composition to preferably no more than about 30% or 25%, and more preferably lower, such as no more than about 20%.

Optionally, other components may be added to the polymer matrix to provide or improve the desired physical properties mentioned earlier in this section. Usually, for good photorefractive capability, it is preferred to add a photosensitizer to serve as a charge generator. A wide choice of such photosensitizers is known in the art. Typical, but non-limiting examples of photosensitizers that may be used are 2,4,7-trinitro-9-fluorenone dicyanomalonate (TNFDM), dinitro-fluorenone, mononitro-fluorenone and C60. The amount of photosensitizer required is usually less than 3 wt %.

In the art, many of the compositions of the photorefractive polymers showed poor phase stabilities and gave haziness after days. Once the composition films showed the haziness, they don't show good photorefractive properties. This film composition haziness is usually coming from incompatibilities between several photorefractive components. Generally, photorefractive compositions comprise components having charge transport ability and components having non-linear optics ability. The components having charge transport ability are usually hydro-phobic and nonpolar material. On the other hand, components having non-linear optics ability are usually hydro-philic and polar material. Therefore, as a nature of these components, there were tendencies to be phase separated and give hazy compositions. In the previously described paper (Macromolecules, 2000, 33, 4074), acrylate-based polymers that include carbazole-based side chains and several stilibene-type side chains comprise components having charge transport ability and the components having non-linear optics ability. In this paper, it is said these polymers can be expected to have good phase stability, although there is no actual detail data.

However, on the other hand, in the present invention, preferred embodiments of the photorefractive composition showed very good phase stabilities and gave no haziness even after several months. They don't change good photorefractive properties, as the compositions are very stable and no phase separations are observed. These film composition stabilities are probably due to chromophore structures and/or mixture of different chromophores, also mainly the matrix polymer system is copolymer of charge transport ability and components having non-linear optics ability. That is, the components having charge transport ability and the components having non-linear optics ability are existing in one polymer chain and phase separation with additional chromophores are irrelevant and unlikely to happen.

Again, interestingly, inventors found this invention chromophore and gave no haziness even after several months, although no clear reasons. On the other hand, preferred embodiments of the invention chromophores which are mixtures of formulae Type-A and Type-B in the above description gave good phase stabilities and gave no haziness even after several months. It is generally known that an existence of several different crystal compositions is likely to be preventing from each composition crystallization. Maybe, this kind of general tendency makes the composition better phase stability and less hazy and unstable.

This good phase stabilities of this invention last more than a day or a week, or sometimes more than six months. Also, even by heating up the testing samples, which usually enhance phase separation speed, preferred embodiments of the samples showed very good phase stability for more than a day or a week, or sometimes more than six months. This good phase stability can facilitate the invention copolymer into optical device applications for more commercial products. For acceleration tests, heating test temperature have no restriction, but usually, the temperature is between 40 and 120° C., preferably between 60 and 80° C.

The photorefractive materials of the invention provide combinations of desirable properties not previously available to the art.

A particularly advantageous feature is the fast response time. Response time is the time needed to build up the diffraction grating in the photorefractive material when exposed to a laser writing beam. The response time of a sample of material may be measured by transient four-wave mixing (TFWM) experiments, as detailed in the Examples section below. The data may then be fitted with the following bi-exponential function:
η(t)=sin²{η₀(1−a₁e^{-t/J1}−a₂e^{-t/J2})²}
with a₁+a₂=1
where η(t) is the diffraction efficiency at time t, η₀ is the steady-state diffraction efficiency, and J₁ and J₂ are the grating build-up times. The smaller number of J₁ and J₂ is defined as the response time.

Response time is important because a faster response time means faster grating build-up, which enables the photorefractive composition to be used for wider applications, such as real-time hologram applications. In the present invention, response time is less than 100 msec. and preferably 50 msec. Since the response time is less than 100 msec., advantages such as quick real-time hologram can be obtained.

Furthermore, these response times can be achieved without resorting to a very high electric field, expressed as biased voltage. By a very high biased voltage, inventors mean a field in excess of about 100 V/μm. In inventors' materials, fast response times can generally be achieved at biased voltages no higher than about 100 V/μm, more preferably no higher than about 90 V/μm.

Yet another advantageous feature is the diffraction efficiency, η. Diffraction efficiency is defined as the ratio of the intensity of the diffracted beam to the intensity of the incident probe beam, and is determined by measuring the intensities of the respective beams. Obviously, the closer to 100% is the ratio, the more efficient is the device.

In general, for a given photorefractive composition, a higher diffraction efficiency can be achieved by increasing the applied biased voltage.

In comparison with typical prior art materials, the photorefractive compositions of the invention provide good diffraction efficiencies, such as at least about 5%, and preferably higher, such as at least about 10%. And, as discussed with respect to photoconductivity, these good diffraction efficiencies can be provided in conjunction with one or more of the other advantageous properties as they are characterized above, such as high photoconductivity, or fast response time, and in conjunction with good processing capabilities, block copolymer capability, and efficient polymerization techniques.

There are two different types of diffraction efficiencies. One is initial diffraction efficiency and another one is diffraction efficiency after certain duration, in order to clarify grating lasting behavior. During holding the grating signals, usually biased voltage is kept on and two writing laser beams are shut-off. In the present invention, initial diffraction efficiency is higher than 30%, and preferably 50%. Since the initial diffraction efficiency is higher than 30%, advantages such as clear image contract can be obtained.

There is no determined and specified duration time. Inventors measured diffraction signal intensity, as measured for initial diffraction efficiency. For inventors' experimental purpose, the inventors set up the duration for 4 minutes as inventors' standard duration tentatively and define this diffraction efficiency as η(4 min.). On the other hand, initial diffraction efficiency was defined as η(initial). In order to compare and figure out grating efficiency conveniently, the value of η(4 min.)/η(initial) is defined as grating holding ratio (%, 4 min.). In the present invention, the grating holding ratio is higher than 10% and preferably 20%. Since the grating ration is higher than 10%, advantages such as clear image can be obtained.

The invention is now further described by the following examples, which are intended to be illustrative of the invention, but are not intended to limit the scope or underlying principles in any way.

### EXAMPLES

### Production Example 1

(a) Monomers Containing Charge Transport Groups

(i) TPD Acrylate Monomer:

TPD acrylate type charge transport monomer(N-[acroyloxypropylphenyl]-N,N′,N′-triphenyl-(1,1′-biphenyl)-4,4′-diamine) (TPD acrylate) was purchased from Fuji Chemical, Japan:

The TPD acrylate type monomer had the structure:

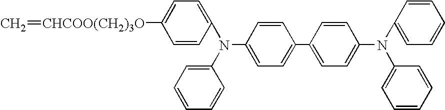

TPD acrylate monomer can be obtained by the following procedure.

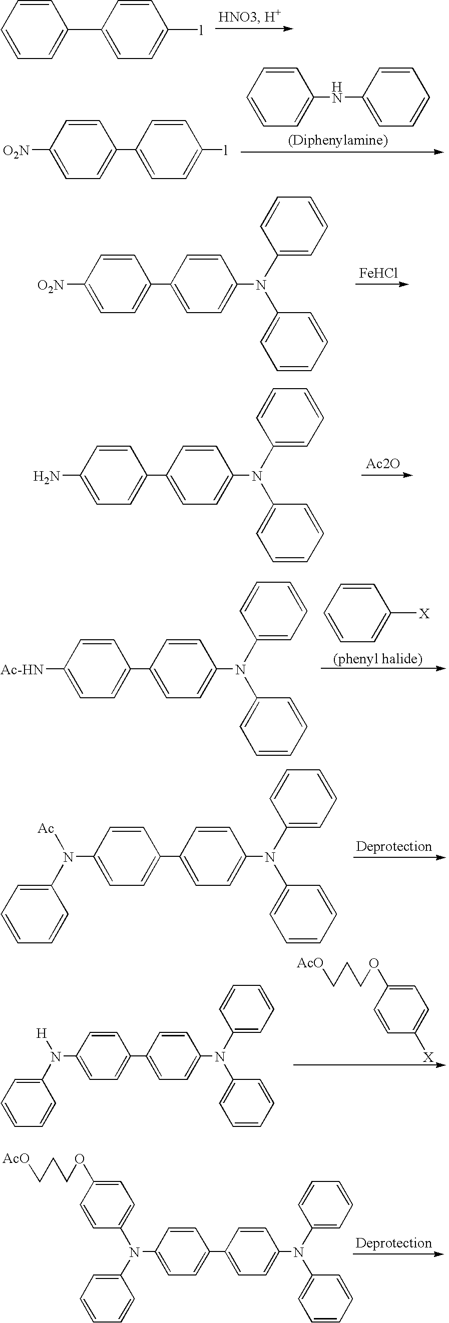

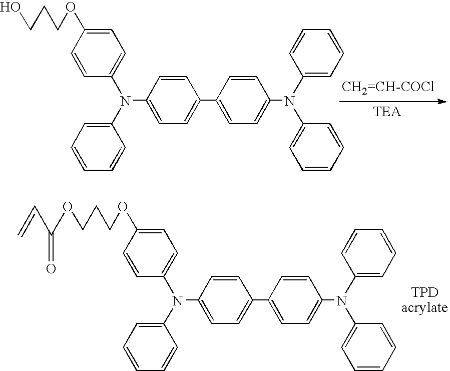

In the above procedure, usage of 3-methyl diphenylamine instead of diphenylamine and 3-methylphenyl halide instead of phenyl halide can result in the formation of N(acroyloxypropylphenyl)-N′-phenyl-N,N′-di(3-methylphenyl)-(1,1′-biphenyl)-4,4′-diamine.

(b) Monomers Containing Non-Linear-Optical Groups

The non-linear-optical precursor monomer 5-[N-ethyl-N-4-formylphenyl]amino-pentyl acrylate was synthesized according to the following synthesis scheme: 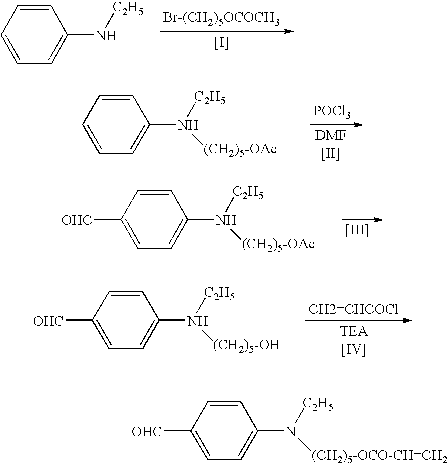
Step I:

Into bromopentyl acetate (5 mL, 30 mmol) and toluene (25 mL), triethylamine (4.2 mL, 30 mmol) and N-ethylaniline (4 mL, 30 mmol) were added at room temperature. This solution was heated at 120° C. overnight. After cooling down, the reaction mixture was rotary-evaporated. The residue was purified by silica gel chromatography (developing solvent: hexane/acetone=9/1). An oily amine compound was obtained. (Yield: 6.0 g (80%))

Step II:

Anhydrous DMF (6 mL, 77.5 mmol) was cooled in an ice-bath. Then, POCl₃ (2.3 mL, 24.5 mmol) was added dropwise into the 25 mL flask, and the mixture was allowed to come to room temperature. The amine compound (5.8 g, 23.3 mmol) was added through a rubber septum by syringe with dichloroethane. After stirring for 30 min., this reaction mixture was heated to 90° C. and the reaction was allowed to proceed overnight under an argon atmosphere.

The next day, the reaction mixture was cooled, and poured into and extracted by ether. The ether layer was washed with potassium carbonate solution and dried over anhydrous magnesium sulfate. After removing the magnesium sulfate, the solvent was removed and the residue was purified by silica gel chromatography (developing solvent: hexane/ethyl acetate=3/1). An aldehyde compound was obtained. (Yield: 4.2 g (65%))

Step III:

The aldehyde compound (3.92 g, 14.1 mmol) was dissolved with methanol (20 mL). Into this mixture, potassium carbonate (400 mg) and water (1 mL) were added at room temperature and the solution was stirred overnight. The next day, the solution was poured into brine water and extracted by ether. The ether layer was dried over anhydrous magnesium sulfate. After removing the magnesium sulfate, the solvent was removed and the residue was purified by silica gel chromatography (developing solvent: hexane/acetone=1/1). An aldehyde alcohol compound was obtained. (Yield: 3.2 g (96%))

Step IV:

The aldehyde alcohol (5.8 g, 24.7 mmol) was dissolved with anhydrous THF (60 mL). Into this mixture, triethylamine (3.8 mL, 27.1 mmol) was added and the solution was cooled by ice-bath. Acrolyl chloride (20.1 mL, 26.5 mmol) was added and the solution was maintained at 0° C. for 20 minutes. Thereafter, the solution was allowed to warm up to room temperature and stirred at room temperature for 1 hour, at which point TLC indicated that all of the alcohol compound had disappeared. The solution was poured into brine water and extracted by ether. The ether layer was dried over anhydrous magnesium sulfate. After removing the magnesium sulfate, the solvent was removed and the residue acrylate compound was purified by silica gel chromatography (developing solvent: hexane/acetone=1/1). The compound yield was 5.38 g (76%), and the compound purity was 99% (by GC).

c) Synthesis of Non-Linear-Optical Chromophore

i) 7-FDCST

The non-linear-optical precursor 7-FDCST (7 member ring dicyanostyrene, 4-homopiperidino-2-fluorobenzylidene malononitrile) was synthesized according to the following two-step synthesis scheme:

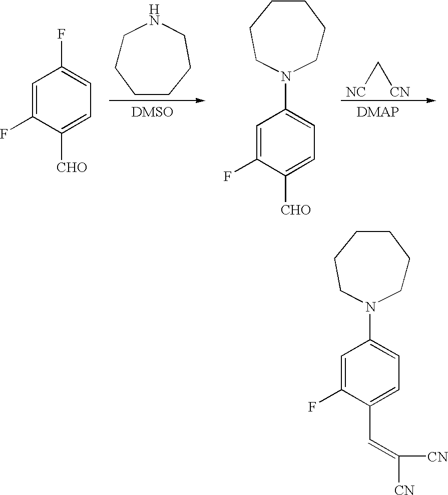

A mixture of 2,4-difluorobenzaldehyde (25 g, 176 mmol), homopiperidine (17.4 g, 176 mmol), lithium carbonate (65 g, 880 mmol), and DMSO (625 mL) was stirred at 50° C. for 16 hr. Water (50 mL) was added to the reaction mixture. The products were extracted with ether (100 mL). After removal of ether, the crude products were purified by silica gel column chromatography using hexanes-ethyl acetate (9:1) as eluent and crude intermediate was obtained (22.6 g). 4-(Dimethylamino)pyridine (230 mg) was added to a solution of the 4-homopiperidino-2-fluorobenzaldehyde (22.6 g, 102 mmol) and malononitrile (10.1 g, 153 mmol) in methanol (323 mL). The reaction mixture was kept at room temperature and the product was collected by filtration and purified by recrystallization from ethanol. Yield (18.1 g, 38%)
ii-a) Synthesis of Fused Ring Chromophore RLC (3a)

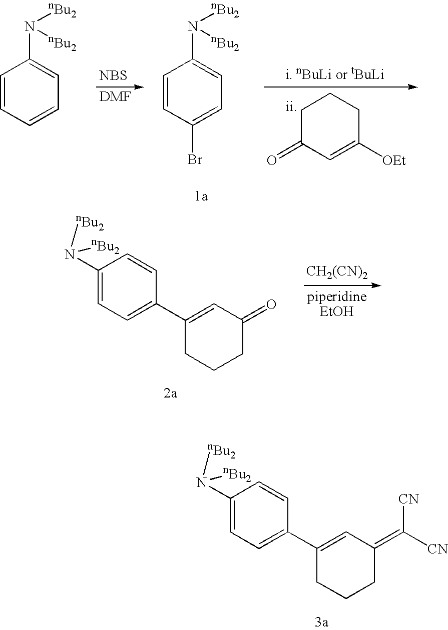

4-Bromo-N,N-di-n-butylaniline (1a). A solution of N-bromosuccinimide (9.61 g, 0.054 mol) in 25 mL DMF (25 mL) was added to a stirred solution of N,N-di-n-butylaniline (11.0 g, 0.054 mol) in 25 mL N,N-dimethylformamide at 0° C. The resulting green solution was stirred for 12 h at ambient temperature and then poured into 1 L water. The mixture was extracted three times with dichloromethane. The combined organic layers were washed subsequently with water and 200 mL of saturated sodium thiosulfate solution, dried over sodium sulfate, filtered and evaporated to yield 1a as a yellowish oil (14.2 g, 0.050 mol, 93%). ¹H NMR (300 MHz, CDCl₃) 7.23 (d, J=9.1 Hz, 2H, CH); 6.48 (d, J=9.0 Hz, 2H, CH); 3.21 (t, J=8.5 Hz, 4H, CH₂N); 1.52 (q, J=7.6 Hz, 4H, CH₂); 1.34 (q, J=7.3 Hz, 4H, CH₂); 0.93 (t, J=7.3 Hz, 6H, CH₃).

2a. n-Butyllithium (18.9 mL of a 2.5 M solution in hexanes, 0.047 mol) was added to a solution of 1a (12.3 g, 0.043 mol in dry diethyl ether at −10° C.). After stirring for 2 h at −10° C., the reaction mixture was allowed to warm up to 0° C. A solution of 1-ethoxy-2-cyclohexen-3-one (6.02 g, 0.043 mol) in diethyl ether was added. The reaction mixture was warmed to ambient temperature and stirred for 2.5 h. After addition of a saturated aqueous solution of sodium chloride, the organic layer was separated. The aqueous layer was extracted with two portions of diethyl ether. The combined organic layers were dried over sodium sulfate, filtered and evaporated to give a residue, which was purified by column chromatography on silica gel with a mixture of hexanes and ethyl acetate as eluent to give 2a as a yellow solid (10.2, 0.034 mol, 79%). ¹H NMR (300 MHz, CDCl₃) 7.46 (d, J=9.0 Hz, 2H, CH); 6.60 (d, J=8.9 Hz, 2H, CH); 6.38 (s, 1H, CH); 3.29 (t, J=7.6 Hz, 4H, CH₂N); 2.72 (t, J=6.0 Hz, 2H, CH₂); 2.42 (t, J=6.6 Hz, 2H, CH₂); 2.08 (q, J=6.3 Hz, 2H, CH₂); 1.56 (q, J=7.5 Hz, 4H, CH₂); 1.34 (sext, J=7.4 Hz, 4H, CH₂); 0.94 (t, J=7.3 Hz, 6H, CH₃).

3a (RLC). The ketone 2a (2.60 g, 8.7 mmol) was dissolved in the minimum amount of refluxing ethanol and malonodinitrile (3.44 g, 52 mmol) were added, along with a catalytic amount of piperidine. The reaction mixture was stirred at 70° C. for 2 h. The conversion of the starting material was monitored by TLC. The reaction was stopped when a side product was observed. The solvent was evaporated and the dark residue was purified by column chromatography on silica gel with a mixture of hexane and ethyl acetate as eluent, followed by recrystallization from ethanol to yield 3a red needles (1.66 g, 4.8 mmol, 55%) with mp. 101-102° C. ¹H NMR (300 MHz, CDCl₃) 7.56 (d, J=9.1 Hz, 2H, CH): 7.12 (s, 1H, CH); 6.61 (d, J=9.1 Hz, 2H, CH); 3.32 (t, J=7.6 Hz, 4H, NCH₂); 2.75 (t, J=6.4 Hz, 4H, CH₂); 1.95 (quint., J=6.3 Hz, 2H, CH₂); 1.52-1.63 (m, 4H, CH₂); 1.29-1.41 (t□d, J_{d}=Jₜ=7.5 Hz, 4H, CH₂); 0.95 (t, J=7.3 Hz, 6H, CH₃).
ii-b) Synthesis of Fused Ring Chromophore APDC (3b)

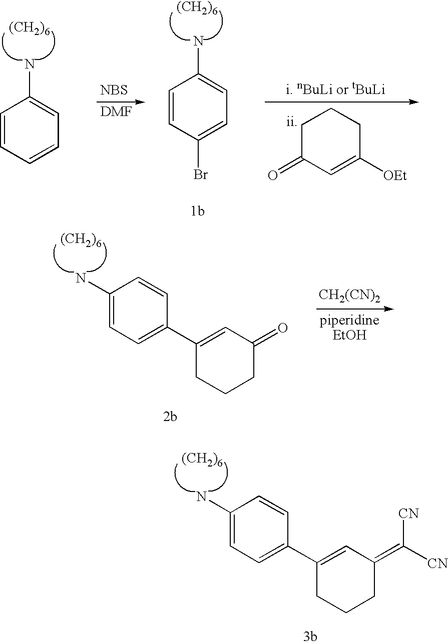

1-Phenyl-azepane was synthesized from the reaction of azepane (also known as hexamethyleneimine and hexahydroazepine), sodium amide, and bromobenzene according to a literature procedure (R. E. Walkup and S. Searles, Tetrahedron, 1985, 41, 101-106). Other starting materials were obtained commercially.

1-(4-Bromophenyl)azepane (1b). A solution of N-bromosuccinimide (1.789 g, 10.1 mmol) in DMF (15 mL) was added dropwise to a solution of 1-phenyl-azepane (1.768 g, 10.1 mmol) in DMF (25 mL) at 0° C. The mixture was allowed to stir and was quenched with 40 mL water after 48 hours. The product was extracted with three 40 mL portions of diethyl ether. The diethyl ether layer was washed with three 40 mL portions of water, then with two 40 mL portions of aqueous 0.01 M sodium thiosulfate, and dried on magnesium sulfate. The diethyl ether was evaporated to afford 1b as a yellowish oil. (1.9721 g, 77.25 mmol, 77% yield). ¹H NMR (CDCl₃, 250 MHz) 7.23 (d, 2H, J=9.2 Hz), 6.53 (d, 2H, J=9.2 Hz), 3.40 (t, 4H, J=5.9 Hz), 1.74 (m, 4H), 1.51 (m, 4H).

2b. 1-(4-Bromophenyl)-azepane (20 g, 78.7 mmol) was dissolved in dry THF (400 mL) under nitrogen gas and cooled to −78° C. tert-Butyl Lithium (92.6 mL of a 1.7 M solution in pentane, 1.45 mol) was added dropwise to the mixture. A solution of 1-ethoxy-2-cyclohexen-3-one (11.45 mL, 78.7 mmol) in dry THF (80 mL) was added dropwise to the mixture. After 36 hours, the reaction was quenched with water (˜250 mL). Reaction was separated with diethyl ether, washed with a saturated sodium chloride solution and dried on magnesium sulfate. The diethyl ether was evaporated and chromatographed on a 8 cm diameter column eluting with 1:1 hexanes/ethyl acetate solution (yellow solid, 16.13 g, 59.8 mmol, 76%). ¹H NMR (CDCl₃, 250 MHz) 7.46 (d, 2H, J=9.0 Hz), 6.66 (d, 2H, J=9.0 Hz), 6.38 (s, 1H, J=2.035 Hz), 3.48 (t, 4H, J=5.88 Hz), 2.72 (t, 2H, J=5.98 Hz), 2.42 (t, 2H, J=6.23 Hz), 2.08 (m, 2H), 1.77 (m, 5H), 1.53 (m, 4H).

3b (APDC). The ketone 2b (7.50 g, 27.8 mmol) and malononitrile (9.5 g, 143.8 mmol) were dissolved in ethanol (300 mL). Pipiridine (˜5 mL) was added to the reaction mixture. Type 4A molecular sieves were added. The reaction mixture turned dark red after a couple of minutes. The reaction was stopped after 4.5 hours. The ethanol was evaporated under reduced pressure. The residue was extracted into ethyl acetate, filtered, and recrystallized to yield a red solid. (7.11 g, 22.4 mol, 80%). ¹H NMR (CDCl₃, 200 MHz) 7.55 (d, 2H, J=8.94 Hz), 7.11 (s, 1H), 6.67 (d, 2H, J=9.1 Hz), 3.51 (t, 4H, J=5.86 Hz), 2.73 (m, 4H), 1.87 (m, 6H), 1.53 (m, 4H).

d) Synthesis of Plasticizer

i) Synthesis of Plasticizer TPA-Ac

The plasticizer TPA-Ac was synthesized according to the following synthesis scheme:

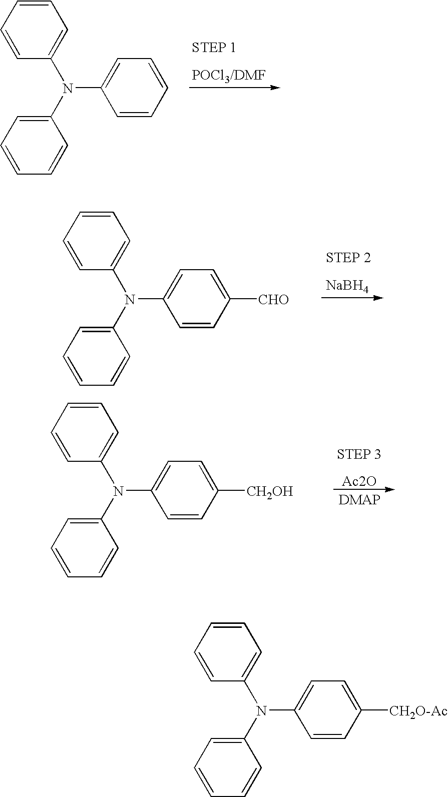

Step 1:

To a cooled solution of DMF anhydride (17 mL) at 0° C. under Argon atomosphere, phosphorousoxychloride anhydride dropwisely (10 mL, 107.3 mmol) was added. After addition completion combined with triphenylamine (30 g, 122.3 mmol) and DMF anhydride (75 mL). Solution was heated to 80° C. overnight. Extracted the reaction mixture with water (500 mL) and CH₂Cl₂ (500 mL). The CH₂Cl₂ layer was rotary-evaporated and purified by column chromatography (7 CH₂Cl₂:3 hexane). Yield was about 21.9 g (66%).

Step 2:

A mixture of above aldehyde (11.71 g, 42.8 mmol), 1:1 solution of toluene and ethanol (150 mL), NaBH₄ (2.43 g, 64.2 mmol) was stirred at room temperature under argon atmosphere. After three hours, the filtered solution was rotary-evaporated and extracted with CH₂Cl₂ (400 mL) and water (400 mL). The collected CH₂Cl₂ layer was rotary-evaporated. Yield was about 12.2 g (quantitively).

Step 3:

To a stirred solution of alcohol (12.17 g, 44.2 mmol), and pyridine (1.8 mL, 22.2 mmol), and tetrahydrafuran anhydride (100 mL) at 0° C. under argon atmosphere was added dropwisely acetic anhydride (6.2 mL, 65.7 mmol). After 45 min, let warm to ambient temperature. The reaction mixture was extracted with water (500 mL) and CH₂Cl₂ (500 mL). The rotary-evaporated CH₂Cl₂ layer was purified by column chromatography (3 ethyl Acetate:1 hexanes). Yield was about 10.5 g (75%).

(e) Other Materials

Besides the above monomers and initiator, other chemicals were purchased from Aldrich Chemicals, Milwaukee, Wis.

### Production Example 2

Preparation of Copolymer by Azo Initiator Polymerization of Charge Transport Monomer and Non-Linear-Optical Precursor Monomer (TPD Acrylate/Chromophore Type 4:1)

The charge transport monomer N-[(meth)acroyloxypropylphenyl]-N, N′,N′-triphenyl-(1,1′-biphenyl)-4,4′-diamine (TPD acrylate) (2.5 g, 4.1 mmol) and the non-linear-optical precursor monomer 5-[N-ethyl-N-4-formylphenyl]amino-pentyl acrylate (0.83 g), prepared as described in Production Example 1 were put into a three-necked flask. After toluene (9.8 g) was added and purged by argon gas for 1 hour, azoisobutylnitrile (9.4 mg) was added into this solution. Then, the solution was heated to 65° C., while continuing to purge with argon gas.

After 18 hrs polymerization, the polymer solution was diluted with toluene. The polymer was precipitated from the solution and added to methanol, then the resulting polymer precipitate was collected and washed in diethyl ether and methanol. The white polymer powder was collected and dried. The yield of polymer was essentially 100%.

As before, the weight average and number average molecular weights were measured by gel permeation chromatography, using a polystyrene standard. The results were Mn=17,462, Mw=34,044, giving a polydispersity of 1.95.

To form the polymer with non-linear-optical capability, the precipitated precursor polymer (2.5 g) was dissolved with chloroform (12 mL). Into this solution, dicyanomalonate (1.0 g, 15.1 mmol) and dimethylaminopyridine (40 mg, 0.33 mmol) were added, and the reaction was allowed to proceed overnight at 40° C. As before, the polymer was recovered from the solution by filtration of impurities, followed by precipitation into methanol, washing and drying.

### Production Example 3

Preparation of Copolymer by Azo Initiator Polymerization of Charge Transport Monomer and Non-Linear-Optical Precursor Monomer (TPD Acrylate/Chromophore Type 3:1)

The charge transport monomer N-[(meth)acroyloxypropylphenyl]-N, N′,N′-triphenyl-(1,1′-biphenyl)-4,4′-diamine (TPD acrylate) (5.5 g, 8.9 mmol) and the non-linear-optical precursor monomer 5-[N-ethyl-N-4-formylphenyl]amino-pentyl acrylate (1.4 g), prepared as described in Production Example 1 were put into a three-necked flask. After toluene (15.4 g) was added and purged by argon gas for 1 hour, azoisobutylnitrile (30 mg) was added to this solution. The solution was then heated to 65° C., while continuing to purge with argon gas.

After 18 hrs polymerization, the polymer solution was diluted with toluene. The polymer was precipitated from the solution and added to methanol, the resulting polymer precipitate was collected and washed in diethyl ether and methanol. The white polymer powder was collected and dried. The yield of polymer was essentially 100%.

As before, the weight average and number average molecular weights were measured by gel permeation chromatography, using a polystyrene standard. The results were Mn=18,255, Mw=34,617, giving a polydispersity of 1.90.

To form the polymer with non-linear-optical capability, the precipitated precursor polymer (5.5 g) was dissolved with chloroform (22 mL). Into this solution, dicyanomalonate (1.06 g, 16.1 mmol) and dimethylaminopyridine (56 mg, 0.46 mmol) were added, and the reaction was allowed to proceed overnight at 40° C. As before, the polymer was recovered from the solution by filtration of impurities, followed by precipitation into methanol, washing and drying.

### Production Example 4

Preparation of Copolymer by Radical Polymerization of Charge Transport Monomer and Non-Linear-Optical Precursor Monomer (TPD Acrylate/Chromophore Type (Living Radical Method))

The charge transport monomer N-[(meth)acroyloxypropylphenyl]-N, N′,N′-triphenyl-(1,1′-biphenyl)-4,4′-diamine (TPD acrylate) (2.75 g, 4.46 mmol) and the non-linear-optical precursor monomer 5-[N-ethyl-N-4-formylphenyl]amino-pentyl acrylate (0.55 g, 1.90 mmol), prepared as described in Production Example 1, bipyridine (110 mg, 0.70 mmol), and toluene (6 mL) were put into a four-necked flask equipped with a mechanical stirrer, a nitrogen inlet, a condenser, and a rubber septum. After purged with argon gas for 1 hr, Br—BMP (54 mg, 0.15 mmol) dissolved with toluene (1 mL) and CuBr (43 mg, 0.30 mmol) were added into this solution. The solution was then heated to 90° C., while continuing to be purged with argon gas.

The polymerization reaction was allowed to proceed with stirring for another 18 hrs. The resulting polymer solution was diluted with toluene, followed by filtration to remove catalyst-related impurities and polymer precipitation into methanol. The precipitated polymer was collected and washed in methanol. The polymer yield was essentially 100%. As before, the weight average and number average molecular weights were measured by gel permeation chromatography, using a polystyrene standard. The results were Mn=9,973, Mw=14,577, giving a polydispersity of 1.46.

To form the polymer with non-linear-optical capability, the precipitated precursor polymer (3.0 g) was dissolved with chloroform (12 mL). Into this solution, dicyanomalonate (570 mg, 8.64 mmol) and dimethylaminopyridine (30 mg) were added, and the reaction was allowed to proceed overnight at 40° C. As before, the polymer was recovered from the solution by filtration of impurities, followed by precipitation into methanol, washing and drying.

### Comparative Production Example 1

Preparation of Homo-Polymer by Azo Initiator Polymerization of Charge Transport Homo-Polymer (TPD Acrylate Type)

The charge transport monomer N-[(meth)acroyloxypropylphenyl]-N,N′,N′-triphenyl-(1,1′-biphenyl)-4,4′-diamine (TPD acrylate, prepared in Production Example 1) (2.5 g, 4.1 mmol,) was put into a three-necked flask. After toluene (9.8 g) was added and purged by argon gas for 1 hour, azoisobutylnitrile (9.4 mg) was added into this solution. Then, the solution was heated to 65° C., while continuing to purge with argon gas.

After 18 hrs polymerization, the polymer solution was diluted with toluene. The polymer was precipitated from the solution and added to methanol, then the resulting polymer precipitate was collected and washed in diethyl ether and methanol. The white polymer powder was collected and dried. The yield of polymer was essentially 100%.

As before, the weight average and number average molecular weights were measured by gel permeation chromatography, using a polystyrene standard. The results were Mn=8,344, Mw=12,600, giving a polydispersity of 1.51.

### Example 1

Preparation of Photorefractive Composition

A photorefractive composition testing sample was prepared. The components of the composition were as follows:

| | | | |
|---|---|---|---|
| (i) | TPD charge transport (described | 60 | wt % |
| | in Production Example 2): | | |
| (ii) | Prepared chromophore of 7-FDCST | 19.0 | wt % |
| (iii) | Prepared chromophore of APDC | 9.5 | wt % |
| (iv) | Prepared TPA Acetate plasticizer | 11.0 | wt % |
| (v) | Purchased TNFDM | 0.5 | wt % |

To prepare the composition, the components listed above were dissolved with toluene and stirred overnight at room temperature. After removing the solvent by rotary evaporator and vacuum pump, the residue was scratched and gathered.

To make testing samples, this powdery residue mixture was put on a slide glass and melted at 125° C. to make a 200-300 μm thickness film, or pre-cake. Small portions of this pre-cake were taken off and sandwiched between indium tin oxide (ITO) coated glass plates separated by a 105 μm spacer to form the individual samples.

Measurement 1

Initial Diffraction Efficiency

The diffraction efficiency was measured at 633 nm by four-wave mixing experiments. Steady-state and transient four-wave mixing experiments were done using two writing beams making an angle of 20.5 degree in air; with the bisector of the writing beams making an angle of 60 degree relative to the sample normal.

For the four-wave mixing experiments, two s-polarized writing beams with equal intensity of 0.2 W/cm² in the sample were used; the spot diameter was 600 μm. A p-polarized beam of 1.7 mW/cm² counter propagating with respect to the writing beam nearest to the surface normal was used to probe the diffraction gratings; the spot diameter of the probe beam in the sample was 500 μm. The diffracted and the transmitted probe beam intensities were monitored to determine the diffraction efficiency. Then, inventors defined this diffraction efficiency as η(initial).

Grating Holding Ratio (%, 4 min.)

The diffraction efficiency was measured at 633 nm by four-wave mixing experiments, after certain duration. In inventors' experiment, inventors measured diffraction efficiency at initial stage and after 4 minutes. Then, inventors defined the ratio [η(4 min.)/η(initial)×100] as grating holding ratio (%, 4 min.).

Measurement 2

Response Time

The diffraction efficiency was measured as a function of the applied field, using a procedure similar to that described in Measurement 1, by four-wave mixing experiments at 633 nm with s-polarized writing beams and a p-polarized probe beam. The angle between the bisector of the two writing beams and the sample normal was 60 degree and the angle between the writing beams was adjusted to provide a 3.1 μm grating spacing in the material (˜20 degree). The writing beams had equal optical powers of 0.45 mW/cm², leading to a total optical power of 0.5 mW on the polymer, after correction for reflection losses. The beams were collimated to a spot size of approximately 500 μm. The optical power of the probe was 4 mW. The measurement of the grating buildup time was done as follows: an electric field of 40 V/μm was applied to the sample, and the sample was illuminated with one of the two writing beams and the probe beam for 100 ms. Then, the evolution of the diffracted beam was recorded. The response time was estimated as the time required to reach half of steady-state diffraction efficiency.

Measurement 3

Phase Stability

The tested samples were put into an oven at 60° C. At certain intervals, the opaqueness of samples was checked by microscope. If there is no opaqueness and crystal inside the composition, the samples could be said to have good phase stability.

Obtained performance:

| | |
|---|---|
| Initial diffraction efficiency (%): | 57% at 70 V/μm |
| Grating holding ratio (%, 4 min.) (%): | 61% at 70 V/μm |
| Response time | 87 (ms) at 70 V/μm |
| Phase stability (at 60° C.): | good |

### Example 2

Preparation of Photorefractive Composition

A photorefractive composition testing sample was prepared. The components of the composition were as follows:

| | | | |
|---|---|---|---|
| (i) | TPD charge transport (described | 60 | wt % |
| | in Production Example 3): | | |
| (ii) | Prepared chromophore of 7-FDCST | 19.0 | wt % |
| (iii) | Prepared chromophore of APDC | 9.5 | wt % |
| (iv) | Prepared TPA Acetate plasticizer | 11.0 | wt % |
| (v) | Purchased TNFDM | 0.5 | wt % |

Obtained performance:

| | |
|---|---|
| Initial diffraction efficiency (%): | 63% at 70 V/μm |
| Grating holding ratio (%, 4 min.) (%): | 62% at 70 V/μm |
| Response time | 82 (ms) at 70 V/μm |
| Phase stability (at 60° C.): | good |

### Comparative Example 1

A photorefractive composition was obtained in the same manner as in the Example 1 except composition rate and components. Particularly, a TPD homo-polymer (Comparative Production Example 1) was used. The components of the composition were as follows:

| | | | |
|---|---|---|---|
| (i) | TPD homo polymer: | 60 | wt % |
| (ii) | Prepared chromophore of RLC | 14.3 | wt % |
| (iii) | Prepared chromophore of APDC | 14.3 | wt % |
| (iv) | Prepared TPA Acetate plasticizer | 10.9 | wt % |
| (v) | Purchased C60 sensitizer (MER, Tucson, AZ) | 0.5 | wt % |

Obtained performance:

| | |
|---|---|
| Initial diffraction efficiency (%): | 68% at 70 V/μm |
| Grating holding ratio (%, 4 min.) (%): | <1% at 70 V/μm |
| Response time | 39 (ms) at 70 V/μm |
| Phase stability (at 60° C.): | good |

As shown in this comparative data which is described in prior art compositions, no grating holding ability was observed, although good Initial diffraction efficiency and fast response time.

It will be appreciated by those skilled in the art that various omissions, additions and modifications may be made to the compositions and methods described above without departing from the scope of the invention, and all such modifications and changes are intended to fall within the scope of the invention, as defined by the appended claims.

What is claimed is:

1. A photorefractive composition which exhibits the following performances:
a) Response time is less than 100 msec.;
b) Initial diffraction efficiency is higher than 30%; and
c) Grating holding ratio which is defined as [η(4 min.)/η(initial)]×100 is higher than 10%, wherein the η(4 min.) is a diffraction efficiency after 4 minutes and the η(initial) is an initial diffraction efficiency.

2. The photorefractive composition of claim 1, which comprises at least two different types of chromophores and a co-polymer, wherein one type (Type-A) of chromophore is selected from the group consisting of formulae (i) and (ii), another type (Type-B) of chromophore is selected from the group consisting of formulae (iii) and (iv), and said co-polymer comprises both a repeating unit including a moiety selected from the group consisting of the structures (x), (xi), and (xii) and a repeating unit of the structure (xvi):
(Type-A): 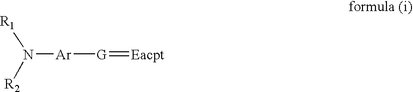
wherein Ar represents an aromatic group, with or without a hetero atom; R₁ and R₂ are each independently selected from the group consisting of a linear alkyl group with up to 10 carbons, a branched alkyl group with up to 10 carbons, and an aromatic group with up to 10 carbons; G is a group having a bridge of π-conjugated bond; and Eacpt is an electron acceptor group; 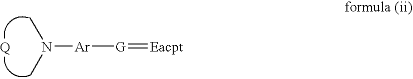
wherein Ar represents an aromatic group, with or without a hetero atom; G is a group having a bridge of π-conjugated bond; Eacpt is an electron acceptor group; and Q represents an alkylene group, with or without a hetero atom;
(Type-B): 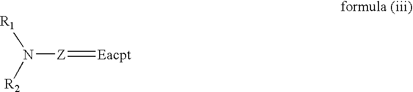
wherein R₁ and R₂ are each independently selected from the group consisting of a linear alkyl group with up to 10 carbons, a branched alkyl group with up to 10 carbons, and an aromatic group with up to 10 carbons; Z is a group having a bridge of π-conjugated bond; and Eacpt is an electron acceptor group; 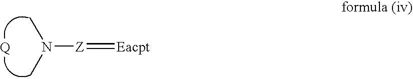
wherein Q represents an alkylene group, with or without a hetero atom; Z is a group having a bridge of π-conjugated bond; and Eacpt is an electron acceptor group;
(Polymer): 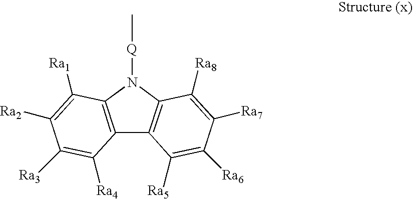
wherein Q represents an alkylene group, with or without a hetero atom; Ra₁, Ra₂, Ra₃, Ra₄, Ra₅, Ra₆, Ra₇, and Ra₈ are independently selected from the group consisting of a hydrogen atom, a linear alkyl group with up to 10 carbons, a branched alkyl group with up to 10 carbons, and an aromatic group with up to 10 carbons; 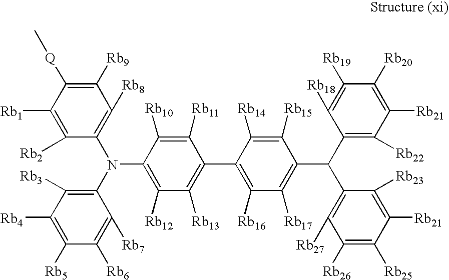
wherein Q represents an alkylene group, with or without a hetero atom; Rb₁-Rb₂₇ are each independently selected from the group consisting of a hydrogen atom, a linear alkyl group with up to 10 carbons, a branched alkyl group with up to 10 carbons, and an aromatic group with up to 10 carbons; 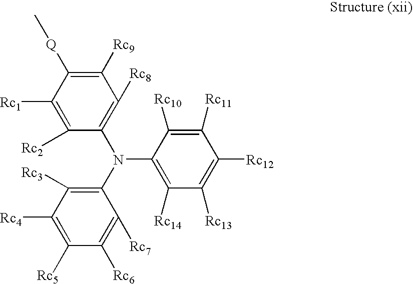
wherein Q represents an alkylene group, with or without a hetero atom; Rc₁-Rc₁₄ are each independently selected from the group consisting of a hydrogen atom, a linear alkyl group with up to 10 carbons, a branched alkyl group with up to 10 carbons, and an aromatic group with up to 10 carbons; 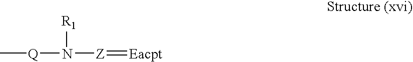
wherein Q, R₁, Z and Eacpt are the same meaning as in formula (iii) or (iv).

3. The photorefractive composition of claim 2, wherein said one type (Type-A) of chromophore is represented by the formula (i): 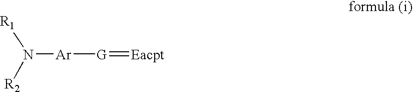
wherein R₁ and R₂ are each independently selected from the group consisting of a linear alkyl group with up to 10 carbons, a branched alkyl group with up to 10 carbons, and an aromatic group with up to 10 carbons; Ar is an aromatic group selected from the group consisting of phenylene, naphthylene, and thiophenylene; G is represented by a structure selected from the group consisting of the structures (v) and (vi);
wherein structures (v) and (vi) are: 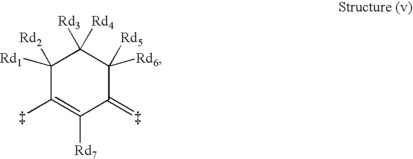
wherein, Rd₁-Rd₇ are each independently selected from the group consisting of a hydrogen atom, a linear alkyl group with up to 10 carbons, a branched alkyl group with up to 10 carbons, and an aromatic group with up to 10 carbons; 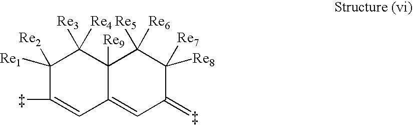
wherein Re₁-Re₉ each independently represent hydrogen or a linear or branched alkyl group with up to 10 carbons; and
wherein Eacpt in the formula (i) is an electron acceptor group represented by a structure selected from the group consisting of the following structures; 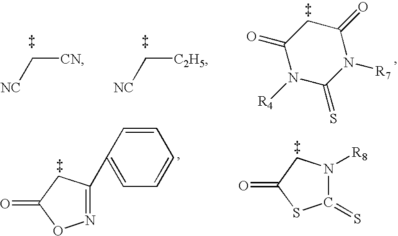
wherein R₅, R₆, R₇ and R₈ are each independently selected from the group consisting of a hydrogen atom, a linear alkyl group with up to 10 carbons, a branched alkyl group with up to 10 carbons, and an aromatic group with up to 10 carbons.

4. The photorefractive composition of claim 2, wherein said one type (Type-A) of chromophore is represented by the formula (ii): 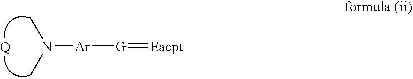
wherein Ar is an aromatic group selected from the group consisting of phenylene, naphthylene, and thiophenylene; Q represents an alkylene group, with or without a hetero atom; G is represented by a structure selected from the group consisting of the structures (v) and (vi);
wherein structures (v) and (vi) are: 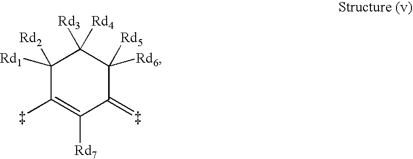
wherein, Rd₁-Rd₇ are each independently selected from the group consisting of a hydrogen atom, a linear alkyl group with up to 10 carbons, a branched alkyl group with up to 10 carbons, and an aromatic group with up to 10 carbons; 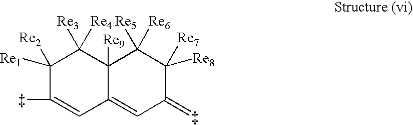
wherein Re₁-Re₉ each independently represent hydrogen or a linear or branched alkyl group with up to 10 carbons, and
wherein Eacpt in the formula (ii) is an electron acceptor group represented by a structure selected from the group consisting of the following structures; 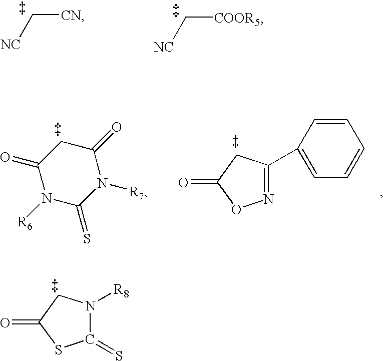
wherein R₅, R₆, R₇ and R₈ are each independently selected from the group consisting of a hydrogen atom, a linear alkyl group with up to 10 carbons, a branched alkyl group with up to 10 carbons, and an aromatic group with up to 10 carbons.

5. The photorefractive composition of claim 2, wherein said another type (Type-B) of chromophore is represented by the formula (iii): 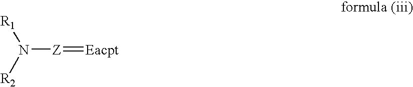
wherein R₁ and R₂ are each independently selected from the group consisting of a linear alkyl group with up to 10 carbons, a branched alkyl group with up to 10 carbons, and an aromatic group with up to 10 carbons; Z is a group selected from the group consisting of the structures (vii) and (viii);
wherein structures (vii) and (viii) are: 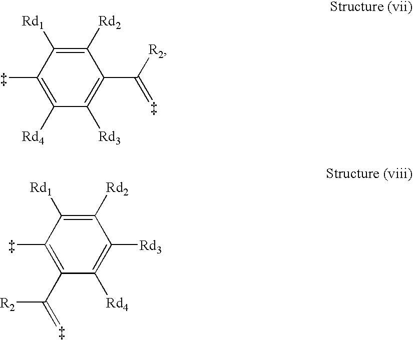
wherein, in both structures (vii) and (viii), Rd₁-Rd₄ are each independently selected from the group consisting of a hydrogen atom, a linear alkyl group with up to 10 carbons, a branched alkyl group with up to 10 carbons, and an aromatic group with up to 10 carbons; R₂ is selected from the group consisting of a hydrogen atom, a linear alkyl group with up to 10 carbons, a branched alkyl group with up to 10 carbons, and an aromatic group with up to 10 carbons; and
wherein Eacpt in formula (iii) is an electron acceptor group represented by a structure selected from the group consisting of the following structures; 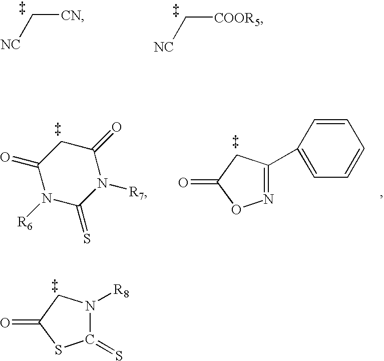
wherein R₅, R₆, R₇ and R₈ are each independently selected from the group consisting of a hydrogen atom, a linear alkyl group with up to 10 carbons, a branched alkyl group with up to 10 carbons, and an aromatic group with up to 10 carbons.

6. The photorefractive composition of claim 2, wherein said another type (Type-B) of chromophore is represented by the formula (iv): 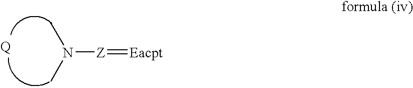
wherein Q represents an alkylene group, with or without a hetero atom; Z is a group selected from the group consisting of the structures (vii) and (viii);
wherein structures (vii) and (viii) are: 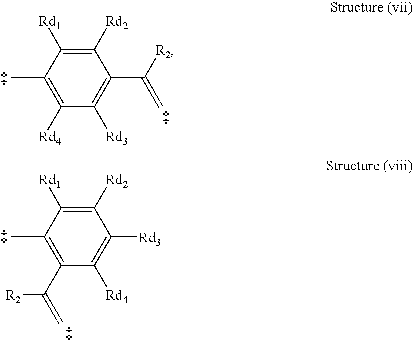
wherein, in both structures (vii) and (viii), Rd₁-Rd₄ are each independently selected from the group consisting of a hydrogen atom, a linear alkyl group with up to 10 carbons, a branched alkyl group with up to 10 carbons, and an aromatic group with up to 10 carbons; R₂ is selected from the group consisting of a hydrogen atom, a linear alkyl group with up to 10 carbons, a branched alkyl group with up to 10 carbons, and an aromatic group with up to 10 carbons; and
wherein Eacpt in formula (iv) is an electron acceptor group represented by a structure selected from the group consisting of the following structures; 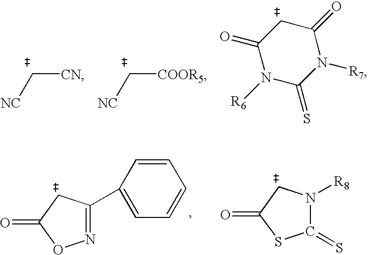
wherein R₅, R₆, R₇ and R₈ are each independently selected from the group consisting of a hydrogen atom, a linear alkyl group with up to 10 carbons, a branched alkyl group with up to 10 carbons, and an aromatic group with up to 10 carbons.

7. The composition of claim 2, wherein the co-polymer comprises both a repeating unit selected from the group consisting of the structures (xiii), (xiv), and (xv) and a repeating unit of the structure (xvii): 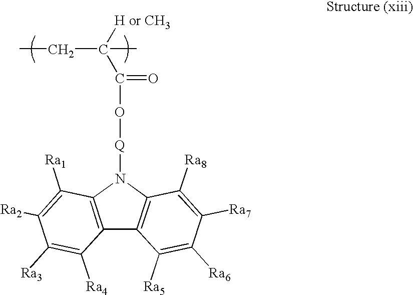
wherein Q represents an alkylene group, with or without a hetero atom; Ra₁, Ra₂, Ra₃, Ra₄, Ra₅, Ra₆, Ra₇, and Ra₈ are independently selected from the group consisting of a hydrogen atom, a linear alkyl group with up to 10 carbons, a branched alkyl group with up to 10 carbons, and an aromatic group with up to 10 carbons; 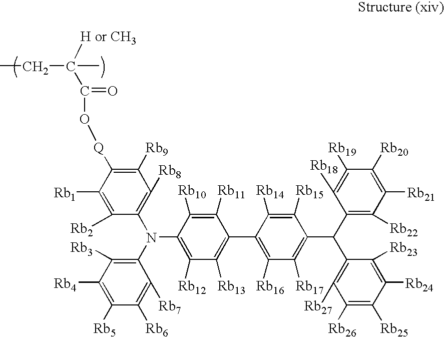
wherein Q represents an alkylene group, with or without a hetero atom; Rb₁-Rb₂₇ are each independently selected from the group consisting of a hydrogen atom, a linear alkyl group with up to 10 carbons, a branched alkyl group with up to 10 carbons, and an aromatic group with up to 10 carbons; 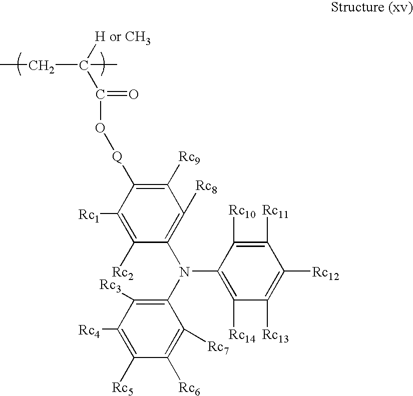
wherein Q represents an alkylene group, with or without a hetero atom; Rc₁-Rc₁₄ are each independently selected from the group consisting of a hydrogen atom, a linear alkyl group with up to 10 carbons, a branched alkyl group with up to 10 carbons, and an aromatic group with up to 10 carbons. 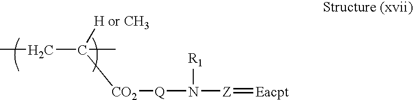
wherein Q, R₁, Z and Eacpt are the same meaning as in formula (iii) or (iv).

8. The composition of claim 2, further comprising a plasticizer and a sensitizer.
